(19) United States
(12) Patent Application Publication
(10) Pub. No.: US 2010/0241610 A1
(43) Pub. Date: Sep. 23, 2010

(54) METHODS AND SYSTEMS FOR PRESERVING AND ACCESSING INFORMATION RELATED TO DECISION-MAKING

(76) Inventors: James Allen GIBSON, Calgary (CA); John Mark CHIDWICK, Bragg Creek (CA); Jonah Callum SIMPSON, Calgary (CA); David Everton BROWN, Cochrane (CA)

Correspondence Address: LAHIVE & COCKFIELD, LLP;FLOOR 30, SUITE 3000, ONE POST OFFICE SQUARE, BOSTON, MA, 02109, US

(21) Appl. No.: 12/407,592

(22) Filed: Mar. 19, 2009

(51) Int. Cl. G06N 5/02; G06F 17/30

(52) U.S. Cl. 706/54; 706/59; 707/E17.014; 707/E17.044

(57) ABSTRACT

Exemplary embodiments provide integrated functionalities for data retrieval, encapsulation and visualization to facilitate a user in making a decision. Exemplary embodiments provide controls which correspond to actions that the user takes in making a decision. The user can use a control to access one or more data sources, send queries to the data sources, retrieve results of the queries, and automatically display the results on a display device. Exemplary embodiments also provide scenarios, each encapsulating a decision-making process. A scenario encapsulates and displays data sources and controls used in making a decision.

### RELATED FIELDS

This application is generally related to the fields of information management and business intelligence. Methods and systems are described for preserving knowledge or information, facilitating decision-making, representing a knowledge base, and providing support systems for decision makers, new employee training, and regulatory compliance, although the methods and systems described herein are not limited to use in the enumerated fields.

### BACKGROUND

Institutions, including but not limited to organizations, businesses, academic institutions, or governmental institutions, may develop a set of institutional knowledge over time as individuals contribute information to the day-to-day practices of the institution. The set of institutional knowledge may include facts, concepts, experiences, opinions, preferences, and know-how developed or retained by individuals or groups employed by or associated with the institutions.

Institutional knowledge or institutional memory may include this collective knowledge held by individuals in an institution. Institutional knowledge may be passed among the people associated with an institution by training, collaboration, problem solving, or other means. However, institutional knowledge may be lost or impaired if an individual leaves an institution without passing on the individual's particular knowledge set. An individual may also forget articles of knowledge throughout the individual's lifetime.

Knowledge may involve varied sets of facts. For example, a civil engineer or a firm specializing in civil engineering, may possess knowledge relevant to load tolerance, the cost of construction materials, names of design firms, ownership and use of intellectual property, and other pieces of information relevant to the firm's particular field. The firm, or individuals within the firm, may also possess other forms of knowledge, including but not limited to information relevant to hiring decisions, office supplies, and information technology.

Knowledge may also pertain to procedures or processes performed by individuals or groups within an institution. For example, human resources department of a firm may implement a common procedure to hire new employees. Such a procedure might involve defining the position, advertising for applicants, reviewing applications, conducting interviews, researching references, making an offer, preparing paperwork, and training the new employee.

Information which may be encompassed by individual or institutional knowledge may also be required to complete regulatory processes, such as compliance with Securities Exchange Commission (SEC) or Internal Revenue Service (IRS) regulations.

To maintain knowledge and facilitate its use, an individual or institution may produce and maintain a number of resources. For example, in a human resources context, a standardized job application document might be developed and maintained. Requisition forms, letter templates, accounting forms, and travel vouchers are other examples of documents that an institution might find useful. Alternatively, a human resources department might write a training manual, or an attorney at a law firm might write a memorandum on a particular legal issue. To maintain and refine common procedures or protocols, individuals or institutions may write checklists, flowcharts, or diagrams. Certain facts may be stored in a database, a number of databases, or in spreadsheets or other documents. Collections of emails may also be stored.

Decisions in knowledge based organizations may be based on a set of information collected from a number of disparate sources. Further, the volume of information is increasing rapidly. Depending on the urgency of the decision, decisions may be made in the absence of sufficient information or delayed due to too much information and lengthy data latency or analysis. Presenting the wrong amount of information to the decision maker, or failing to provide information to the decision maker at the right time, can be detrimental to the decision-making process. If the decision maker is provided with too much information, the decision may be over analyzed. In contrast, if the decision maker is provided with too little, the decision may be ill-informed. By understanding the business drivers and demands, the decision maker can design a decision facility that provides the right data in the right way, establishing trust in the information and confidence in the decisions.

Effective decision makers may be more collaborative in modern organizations. Computer literate decision makers may be more prone to integrate the opinions and experiences of their peers than decision makers in the past.

Often information is located in different places within an institution, and is held by different individuals, or is available in different formats. For example, some facts may be stored in several different databases, spreadsheets, word processing documents, and in emails. Forms may be stored as editable or non-editable documents on a central server, or on individual computers throughout an institution, or solely on computers in a specific department of the institution.

This distributed nature of information within an institution may create difficulties when data analysis or decision making require current information to be collected from different locations and media. For example, when information is stored across different media (e.g., a database and a spreadsheet, or two different databases), it may be difficult to use information stored in one medium in conjunction with information stored in a different medium. In addition, manually collecting large amounts of information from different locations and media may become prohibitively expensive and time-consuming.

Knowledge may be used in a decision making process. For example, if a firm specializing in bridge construction is evaluating a number of bids submitted by subcontractors, the firm may use information related to the past performance of particular subcontractors, the cost of materials, and details about the project. If an individual leaves the institution without persisting institutional knowledge, the decision-making process may suffer from a lack of available information.

### SUMMARY

Methods and systems are provided herein for identifying, persisting, accessing, visualizing, and using knowledge. Methods and systems are also provided to assist decision-making by facilitating collaboration and access to reusable articles of knowledge and information about previous decisions. By providing a framework for interactive, shared and collaborative decisions, decision makers can be more effective at reducing decision latency and improving business performance.

Exemplary embodiments provide integrated functionalities for data retrieval, encapsulation and visualization to facilitate a user in making a decision. Exemplary embodiments may provide one or more controls which correspond to actions that the user takes in making a decision. The user may use a control to access one or more data sources, send queries to the data sources, retrieve results of the queries, and automatically display the results on a display device. Exemplary embodiments may also provide one or more scenarios which encapsulate decision-making processes. A scenario may encapsulate and display the data sources and controls used in making a decision.

In an exemplary embodiment, a computer-implemented method is provided for retrieving and visualizing data. The method includes providing a control for performing a data-related action, the control comprising an input connection and a data visualizer. The method also includes configuring the input connection of the control to connect to an input data source, and entering a query at the control. The method further includes using the input connection to retrieve a result of the query from the input data source, and displaying the result of the query in the data visualizer on a display device.

In another exemplary embodiment, an electronic-device implemented method is provided for encapsulating a decision-making process as a scenario. An interface may be provided on a display device for providing a decision and a resource related to the decision or a reference to a resource related to the decision. A control related to the decision may be defined. When executed by a processor of the electronic device, the control may cause an electronic device to perform an action related to the decision or resource. The decision and the resource or the reference to the resource may be encapsulated as an asset. The asset, the problem and the control may be encapsulated as a scenario. The encapsulated scenario may be stored in a storage of the electronic device, for example in a library. The encapsulated scenario may also be displayed, for example on a display device.

In yet another exemplary embodiment, an affinity is calculated that measures the relationship between the initial scenario and a second scenario. The affinity may be calculated based on the similarity between the resources encapsulated by the initial scenario and the second scenario. With an understanding of how one decision relates to another based on attributes and a formal specification of a knowledge source, such as an ontology, it is possible that unexpected relationships in the information are exposed. Using the affinity, the system is able to provide related information that was not directly requested, which may provide insights that were not expected.

In still another exemplary embodiment, performance metrics that are used to indicate the quality of a decision may be encapsulated as part of the scenario. Performance variables, encapsulated as part of the asset, may provide a metric for measuring aspects of the results generated by the decision for comparison to the performance metrics.

In a further exemplary embodiment, the problem and a resource are stored as a template. The template may be updated in response to the scenario that the template is based on being updated. The resources or the problem may be entered into the scenario from a template.

Exemplary embodiments may also provide a control as part of the scenario. Executing the control may cause an action related to the scenario to occur, such as the visualization or filtering of a data source.

In some embodiments, a relevant portion of a formal specification of a knowledge source may be encapsulated as part of the scenario. The formal specification may provide a structure for the knowledge source.

### BRIEF DESCRIPTION OF THE DRAWINGS

FIG. 1 is a component diagram depicting an electronic device 100 suitable for use with exemplary embodiments described herein.

FIG. 2 depicts a general overview of the interaction between modules suitable for use with exemplary embodiments described herein.

FIG. 3 depicts the modules of FIG. 2 in an environment suitable for use with exemplary embodiments described herein.

FIG. 4 is a flowchart depicting an exemplary procedure carried out by Alignment Module 162 to align a collection of information or knowledge source for use with the other modules.

FIG. 5 depicts an exemplary Alignment Module 162 for use with exemplary embodiments described herein.

FIG. 6 depicts an exemplary Knowledge Module 164 for use with exemplary embodiments described herein.

FIG. 7 depicts two exemplary databases 710, 720 that may be included in knowledge sources.

FIG. 8 depicts an exemplary ontology with two classes.

FIG. 9 is a flowchart depicting exemplary steps taken by the Knowledge Module 164 to provide Knowledge Sources 610 and Knowledge Server 620.

FIG. 10 depicts an exemplary User Interface 1040 that may be displayed to receive queries to a Formal Specification 622.

FIG. 11 is a flowchart depicting exemplary steps taken in using the Knowledge Server 620, in accordance with exemplary embodiments.

FIG. 12 depicts an exemplary framework for a Template 1200 suitable for use in exemplary embodiments.

FIG. 13 depicts an exemplary framework for a Scenario 1300 suitable for use in exemplary embodiments.

FIG. 14 depicts an exemplary GUI 1400 provided by the Visualization and Storage Module 168 for display on a display device 130.

FIG. 15 depicts a main menu and a scenario menu presented in an exemplary GUI 1400.

FIG. 16 depicts an online collaboration option that takes the form of a conversation window 1610 associated with the messaging unit 1430.

FIG. 17 depicts an online collaboration option that takes the form of a conversation window 1710 associated with the messaging unit 1430.

FIG. 18 depicts notifications in a notification menu 1810.

FIG. 19 depicts an exemplary control 1900 in which the control is embodied as a block

FIG. 20 is a flowchart depicting the creation and use of a control 1900 in a scenario 1300.

FIG. 21 depicts an exemplary process of configuring an input connection 1920.

FIG. 22 depicts the input connection of FIG. 21 after configuration, in which the input connection 1920 is associated with a name 2210 of a selected input data source

FIG. 23 depicts an exemplary list 2310 presented for the output connection 1930.

FIG. 24 depicts the output connection of FIG. 23 after configuration, in which the output connection is associated with the display of a graph 2410

FIG. 25 depicts the data visualizer 2500 of an exemplary control.

FIG. 26 depicts a data visualizer display 2600 of an ontology.

FIG. 27 depicts an alternate data visualizer representation 2700 of the same ontology as in FIG. 26

FIG. 28 an exemplary scenario 2810 named “Decision Scenario 1.”

FIG. 29 depicts an example of data display in the scenario 2810.

FIG. 30 is an exemplary flowchart for creating a new scenario.

FIG. 31A depicts an exemplary dialog box that allows a user to enter a description of a Question or Problem 1310 to be addressed by a decision

FIG. 31B depicts an exemplary dialog box that allows a user to invite other users or collaborators to contribute information, ideas, or resources to the decision-making process.

FIG. 32 depicts an exemplary file upload dialog for uploading Files 1330 for use in a scenario.

### DETAILED DESCRIPTION

Past decisions can be used to improve a current decision-making process. For example, if an individual within the human resources department of an institution has gone through the process of hiring a new employee a number of times, that individual may gain expertise in the hiring process. Having seen a number of hiring processes, the individual may be able to identify which decisions were good decisions and which were bad decisions. By examining the factors that went into a certain decision, that individual may be able to improve future decision making for the institution. Past decisions, whether good or bad, may also be useful in training new employees. According to one exemplary embodiment, users may to contribute to, store, and retrieve decisions and the resources and information that went into the decision-making process. In this way a stored decision-making process may be utilized for training and the improvement of future decision-making processes.

Decision making processes may involve repetitive tasks or reusable documents. For example, a human resources department may perform the same procedures each time they hire a new employee. Alternatively, the human resources department may use the same forms each time they hire a new employee. Accordingly, common workflows, documents, and other information within an institution's knowledge base may be used over and over again. As a result, an institution may wish to streamline the use of certain information or articles of knowledge. According to another exemplary embodiment, common tasks, procedures, workflows, and documents employed in a decision making process may be integrated into a template or scenario that facilitates access to, and the use of, these resources.

Exemplary embodiments provide integrated functionalities for data retrieval, encapsulation and visualization to facilitate a user in making a decision. Exemplary embodiments may provide one or more controls which correspond to actions that the user takes in making a decision. The user may use a control to access one or more data sources, send queries to the data sources, retrieve results of the queries, and automatically display the results on a display device. Exemplary embodiments may also provide one or more scenarios which encapsulate decision-making processes. A scenario may encapsulate and display the data sources and controls used in making a decision.

Exemplary embodiments may provide automated and streamlined means of collecting information from different sources within an institution, which allows a user to quickly and easily collect information necessary in decision-making or data analysis. Exemplary embodiments may also provide means for querying relevant data over different information sources to obviate the need to separately query each source. Exemplary embodiments may store all information used in making a prior decision, and may also store information that may be reused within the institution.

### I. Electronic Device for use in Exemplary Embodiments

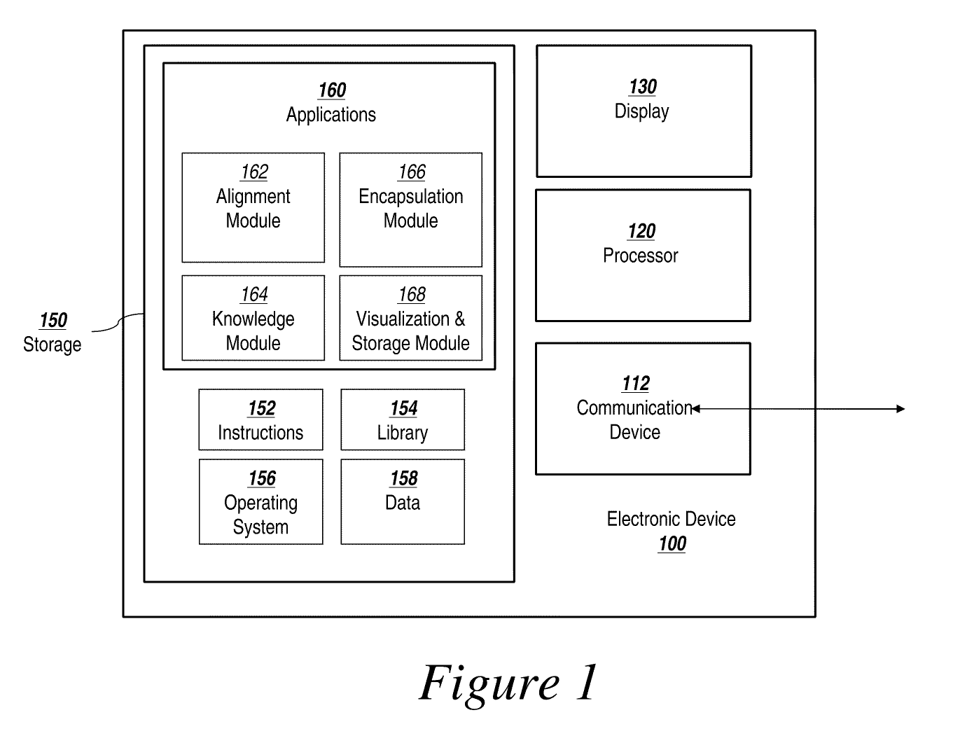

FIG. 1 depicts an electronic device 100, e.g. a computer, suitable for use with the exemplary embodiments described herein. Electronic device 100 may contain a storage 150 for storing computer-executable instructions 152 to be executed by a processor 120, such as a microprocessor, application specific integrated circuit (ASIC), field-programmable gate array (FPGA), or a controller. Instructions 152 may be embodied in one or more computer-readable media, and may implement the functionality of exemplary embodiments described herein. The media may be, but are not limited to, a hard disk, a compact disc, a digital versatile disc, a flash memory card, a programmable read only memory (PROM), a random access memory (RAM), a read only memory (ROM), magnetoresistive random access memory (MRAM), magnetic storage media, or optical storage media. Instructions 152 may cause processor 120 to perform a series of steps described in detail below. Instructions 152 may be in any form that describes how to perform these steps. For example, the instructions may be uncompiled code in any suitable programming language, compiled code, assembly language instructions, or any other type of instructions.

Storage 150 may store any modules, outputs, displays, files, information, user interfaces, etc, provided in exemplary embodiments. Storage 150 may store Applications 160 for use by electronic device 100 or another electronic device. Applications 160 may include programs, modules, or software components that allow electronic device 100 to perform tasks. Examples of Applications 160 include word processing software, shells, Internet browsers, productivity suites, and programming software. In one embodiment, Electronic Device 100 may include modules 162, 164, 166, 168 for preserving, recalling, and facilitating access to knowledge and decisions. These modules may include: Alignment Module 162, for identifying key areas of knowledge for preservation and data sources for further treatment by the other modules; Knowledge Module 164, for formally representing knowledge sources; Encapsulation Module 166, for encapsulating resources, such as relevant information, data, collaborations, events, and other aspects of decision making; and Visualization and Storage Module 168, for facilitating access to knowledge and decisions. The modules may be, for example, software components or computer programs.

Storage 150 may also store an operating system 156 for operating electronic device 100. Storage 150 may store additional applications 160 for providing additional functionality, as well as data 158 for use by the electronic device 100 or another device. Data 158 may include files, variables, parameters, images, text, and other forms of data. Storage 150 may also store a library 154, such as a library maintained by Visualization and Storage Module 168. Library 154 may be used, for example, to store default or custom assets, scenarios, templates, and controls, which will be described in more detail below.

Electronic device 100 may have a communication device 112 for communicating with communication network 110. Communication device 112 may be, for example, a modem, an Ethernet connection, a fiber optic connection, a radio antenna, or any suitable means for communicating with a network. Examples of communication networks include, but are not limited to, the Internet, Ethernet networks, Fiber Optic Networks, WiFi networks, UMTS terrestrial radio access network (UTRAN) or universal mobile telecommunications System (UMTS) networks, code division multiple access (CDMA) networks, WiMax Networks, and ultra mobile broadband (UMB) networks, among others.

Optionally, electronic device 100 may have a display device 130 for displaying any outputs, displays, files, information, user interfaces, etc, provided in exemplary embodiments. Display device 130 may display a Graphical User Interface (GUI), such as an interface provided by the Visualization and Storage Module 168. Display device 130 may be, for example, a computer monitor, television, touch screen, tablet or slate computer, or any other device capable of displaying information.

### II. Overview of Modules

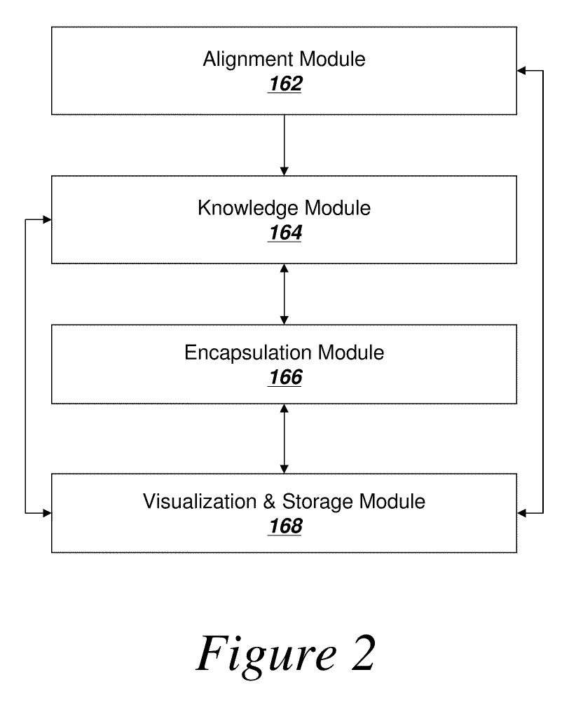

FIG. 2 depicts an exemplary business intelligence suite that includes modules for accessing, preserving, storing, and facilitating the use of information. The information may be used to reach a decision or store information related to a decision already made.

Alignment Module 162 carries out an alignment process that identifies areas of knowledge or information for further treatment by the other modules. In this way, Alignment Module 162 “aligns” a body of knowledge or collection of information with the remaining modules.

Alignment Module 162 may interact with Knowledge Module 164. Knowledge Module 164 encapsulates and structures data specified by Alignment Module 162. Knowledge Module 164 provides a representation of knowledge or information for use by Encapsulation Module 166 and Visualization and Storage Module 168.

Encapsulation Module 166 may interact with Knowledge Module 164 and Visualization and Storage Module 168 in order to identify, acquire, interpret, and assemble inputs to be encapsulated. Encapsulation Module 166 further provides encapsulated templates, assets, and scenarios to the other modules.

Visualization and Storage Module 168 provides an integrated approach to viewing and using controls, scenarios and assets. Functionalities provided by Visualization and Storage Module 168 include, but are not limited to, providing access to existing controls, templates, scenarios and assets, allowing a user to create the aforementioned components, displaying information encapsulated by these components, and allowing collaboration among users. Visualization and Storage Module 168 may also store controls, templates, scenarios, and assets in a library 154.

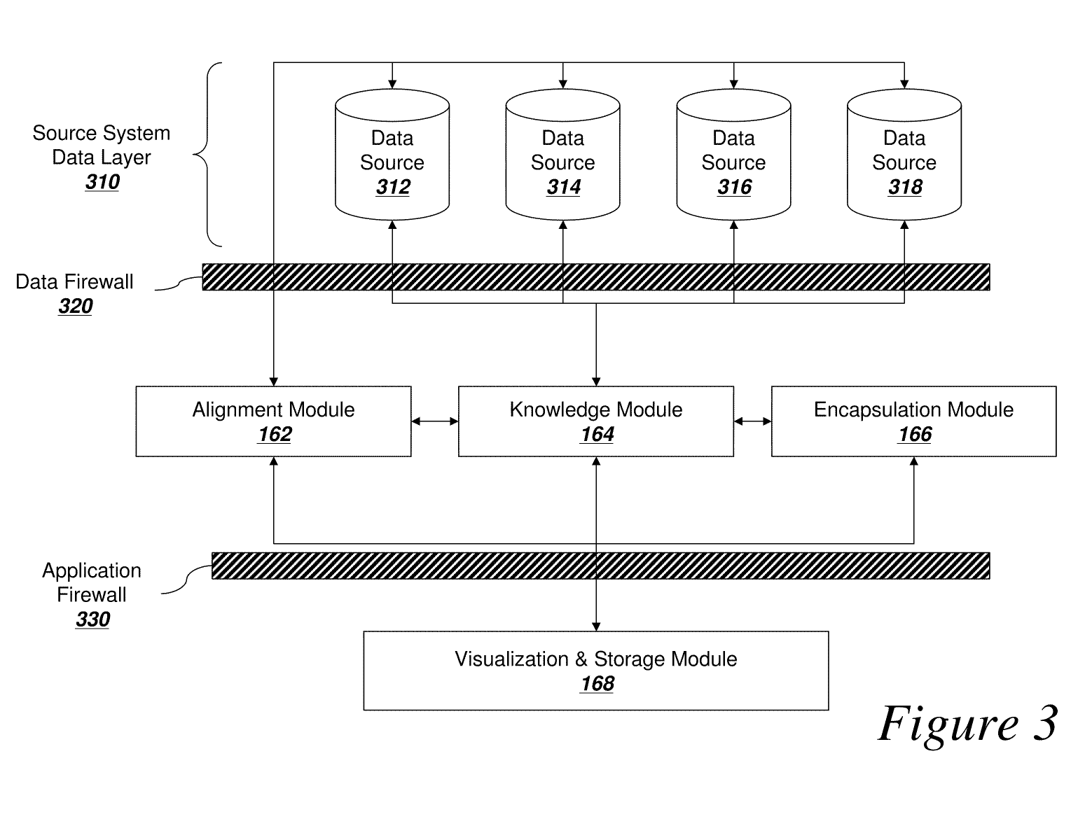

As shown in FIG. 3, a Source System Data Layer 310 may include a number of Data Sources 312, 314, 316, 318. Source System Data Layer 310 may represent, for example, the cumulative sources of data available within an organization. Data Sources 312-318 represent individual sources of data, files, information, documents, emails, or other resources, and may be located in a single location, such as a centralized file server, or may be spread among several locations, such as a group of personal computers, personal digital assistants, file servers, email servers, or other devices. Data Sources 312-318 may optionally sit behind a Data Firewall 320. Data Firewall 320 restricts access to Data Sources 312-318. For example, Data Firewall 320 may restrict access to a particular data source based on a level of security clearance within an organization.

Alignment Module 162, Knowledge Module 164, and Encapsulation Module 166 may sit on the opposite side of Data Firewall 320 from Data Sources 312-318. As information is stored, encapsulated, and accessed by these modules, the Data Firewall 320 may restrict user access to particular Data Sources 312-318, or subsets of data within Data Sources 312-318. This may allow access to information related to decision making to be restricted to certain users or groups of users. For example, if a sensitive decision related to a company's financial information is encapsulated by Encapsulation Module 166, the individual or group responsible for making the decision may desire to restrict access to the decision only to a certain subgroup of people. Data Firewall 320 may be configured to allow a subgroup access to the decision, while preventing the rest of the company from viewing information related to the decision.

Alignment Module 162 and Knowledge Module 164 may access Data Sources 312-318 through Data Firewall 320. Knowledge Module 164 may receive data directly from Data Sources 312-318, or Alignment Module 162 may provide Knowledge Module 164 with relevant data.

Alignment Module 162, Knowledge Module 164, and Encapsulation Module 166 may sit behind Application Firewall 330. Application Firewall 330 restricts certain programs from running on certain systems, and restricts user access to different Applications. For example, Application Firewall may prevent users from changing settings related to Alignment Module 162, Knowledge Module 164, and Encapsulation Module 166. Visualization and Storage Module 168 may interact with the other modules through Application Firewall 330.

### III. Alignment Module

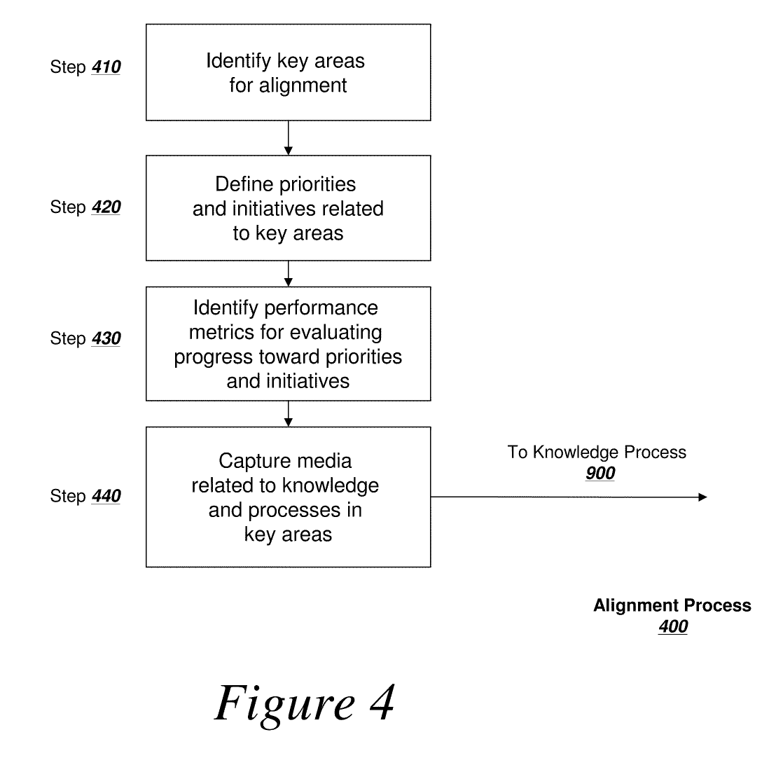

As depicted in FIG. 4, Alignment Process 400 performed using Alignment Module 162 identifies areas of knowledge which may be further treated by the other modules and identifies resources within the areas of knowledge so that the other modules may preserve and facilitate access to those resources. Alignment process 400 may select specific areas of knowledge or departments within an institution for treatment by encapsulation module 164 and Knowledge Module 166. In this way, Alignment Process 400 may “align” a target knowledge-base with the other modules.

At step 410 Alignment Process 400 may identify key areas for alignment. “Areas” are subdivisions of a larger unit and may be, for example, departments within an organization, field offices, tasks performed by the organization, or distinct fields of knowledge. For example, an institution may be divided into a human resources department, an information technology department, and a legal department, and each department could be considered a different area. Alternatively, the organization may have offices in Toronto, New York City, Los Angeles, and Chicago, and each office could be considered different areas. An organization may perform a number of tasks, such as “hiring an employee,” “building a bridge,” and “complying with SEC reporting requirements,” and each task may be considered different institutional areas. Further, different domains of knowledge, such as “civil engineering,” “medicine,” “hiring practices,” and “mining” may be considered different areas for purposes of step 410.

Depending on a number of factors, such as the cost of deploying the system or modules, the estimated effectiveness of the system, and the relative effectiveness of the system among different areas, an individual or institution may select all or only some of the areas for alignment. Selected areas, or “key areas” are further evaluated at steps 420 to 440.

Different areas may benefit in different ways from treatment by Encapsulation Module 162 and Knowledge Module 164. In order to decide which key areas to select for Alignment Process 400, an individual or institution may consider a number of factors. For example, areas involving repeatable decisions or reusable resources may benefit from alignment. By representing repeatable decisions or reusable resources in the knowledge module 164, users of the system may gain fast, efficient, streamlined access to the factors that go into making a repeatable decision or resources that the users may need to access multiple times.

In addition, areas that might benefit from collaboration may benefit from alignment. Because the system facilitates collaboration within and among different areas, a user of the system may gain insight into their own area from someone in a different area that they otherwise would not have consulted. Further, by representing knowledge in one area in a centralized, accessible way, multiple users can access the same information efficiently, improving the users' ability to share insights.

Areas of inefficiency may benefit from alignment. For example, if each area represents a branch of an organization, poorly-performing branches may benefit from the knowledge and collaboration made available from the other branches. If there appears to be a problem in one area but no cause or solution is readily apparent, then the problem may be resolved when relevant information is made available through the Visualization and Storage Module 168.

Areas involving a large knowledge base or a large number of knowledge sources may also benefit from alignment. Because the system provides efficient and streamlined access to a knowledge base, users can find, access, update, maintain, and add to information in the knowledge base in a simple way.

Identifying key areas for alignment may be performed automatically by Alignment Module 162, for example by automatically evaluating the above-described factors. Alignment Module 162 may, for example, assign an Alignment Factor to each subdivision of an organization or area of knowledge based on the above-described factors. The Alignment Factor may be a numeric value, or a data structure. By comparing Alignment Factors, Alignment Module 162 may decide which areas will most benefit from further treatment by the remaining modules. For example, the Alignment Factors may be evaluated against a threshold, and each area with an Alignment Factor above the threshold may be selected for further treatment. Alternatively, a user or users may assign custom Alignment Factors to areas, or may manually select key areas and enter the selected key areas into the Alignment Module 162.

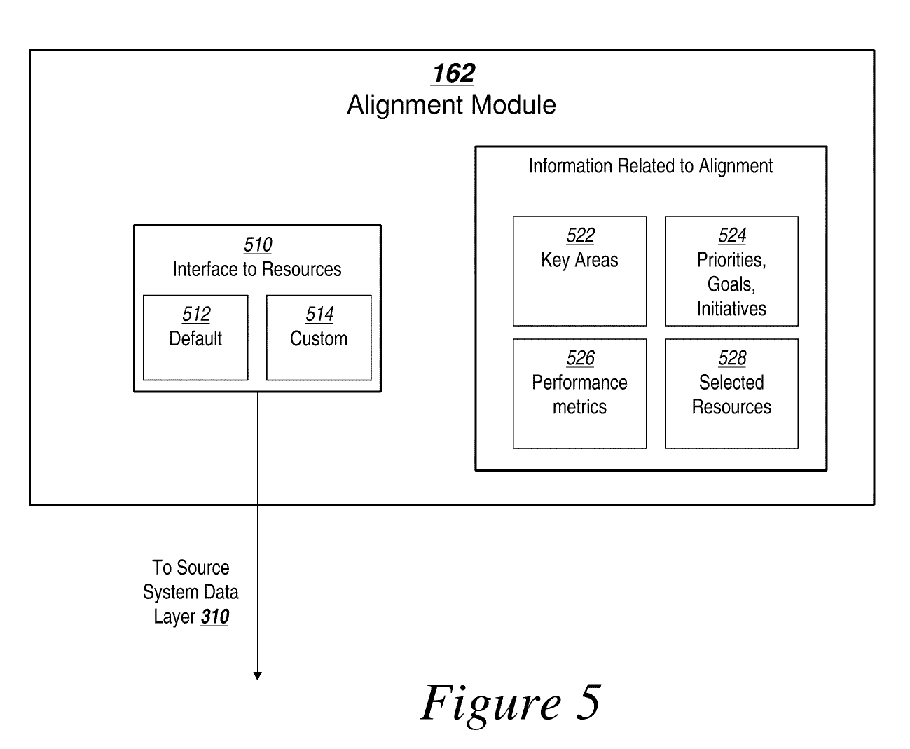

An exemplary Alignment Module 162 is depicted in FIG. 5. In order to identify key areas 522 for alignment or perform other steps, Alignment Module 162 may interface with resources available through the target of evaluation (for example, the evaluated organization). Resources may be provided in multiple different formats or on multiple forms of media. Alignment Module 162 may include an Interface 510 for identifying a resource type and interpreting the information available from the resource. Interface 510 of Alignment Module 162 may include a set of default interfaces 512 for interpreting preselected types of resources, such as databases, spreadsheets, text documents, flow charts, and other common resource types. Interface 510 of Alignment Module 162 may also be extensible with custom interfaces 514 for interpreting other document types not recognized by the default interfaces 512. Resources may be provided in the Source System Data Layer 310, which may be a single location or multiple locations where resources are stored, provided, or processed.

Referring again to FIG. 4, once key areas 522 are identified for alignment at step 410, current priorities and initiatives may be identified and defined at step 420. Step 420 allows a user to identify aspects of the key areas that will allow an individual or institution to measure the progress of the individual or institution towards defined goals. Step 420 may involve identifying outstanding and upcoming decisions, identifying outstanding and upcoming projects, set goals, and recognize key areas of knowledge that should be developed, maintained, and persisted. Priorities and initiatives may be automatically identified by Alignment Module 162, for example by searching resources such as annual reports and shareholder statements or evaluating data associated with an organization or individual against default goals, or custom priorities may be manually entered into Alignment Module 162 by a user or users. If resources are searched, Alignment Module 162 may employ Interface 510 to interpret the resources.

After priorities and initiatives 524 are defined at step 420, performance metrics that measure progress on priorities and initiatives are identified. Performance metrics may also measure the quality of an outcome, measure how good or bad a decision is, or provide a context for decision-making. Performance metrics may be compared to variables related to an outcome to determine the quality of the outcome. Performance metrics may allow an individual or institution to concretely see how they are progressing towards their goals, and may help to evaluate between different options for achieving those goals. Performance metrics may be provided by Alignment Module 162 from a default set of performance metrics, or a user or users may create custom sets of performance metrics and enter the custom sets into Alignment Module 162.

One example of a performance metric 526 is an efficiency metric. Examples of efficiency metrics include, but are not limited to, productivity, resource usage, number of personnel used for a particular project, liquidity rates, and success rates. Another example of a performance metric is a cost metric. Cost metrics may reflect, for example, a gross cost, net cost, depreciated cost, amortized cost, or opportunity cost. Cost may be measured in, for example, capital, time, human costs, or using other standards. Cost metrics may reflect the outlay required to purchase, repair, or maintain an object, project, individual, department, organization, relationship, or may reflect other costs.

Quality metrics may be provide a value for an object, relationship, experience, or individual. Examples of quality metrics include, but are not limited to, a rating for goods or services, the rate at which a product is returned to the manufacturer, a rating provided by a government, industry organization, consumer group, watchdog group, or other ratings-provider, an estimated useable lifetime of a good, or the estimated value of a good or service after a predetermined period of time.

Service metrics may provide a rating or value for a service. Examples of service metrics may include customer satisfaction ratings, the rate at which a product is returned to a manufacturer, the quality of a service, the availability or “uptime” of a service or service-provider, and other indicators of the quality of service provided by an individual, organization, system, software, or facility.

Market metrics may reflect an individual, organization, product, or service's place in a market. Examples of market metrics include market share, ratings among competitors, the demographics of a target or actual market for a product or service, or the perceived value of a product or service among consumers. In addition, brand metrics may be employed to evaluate the recognition or value of a particular brand of goods, services, individuals, or organizations. Examples of brand metrics may include brand recognition or positive or negative reactions to a brand among individuals or groups, such as a target market.

Alignment Module 162 may capture institutional knowledge and processes at step 440 by selecting resources 528 for alignment. Based on the key areas 522 identified at step 410, the projects and initiatives 524 identified at step 420, and the performance metrics 526 identified at step 430, Alignment Module 162 may search among the resources available to the individual or organization to select the resources that may benefit from further treatment by the Knowledge Module 164 and Encapsulation Module 166. The Alignment Module 162 may automatically select examples of institutional knowledge and processes from among the resources of the organization or individual, for example by performing a search of available resources in Data Sources 312-318 for target keywords, authors, creation dates, modification dates, descriptions, or other values. Alternatively, a user or users may select resources from among available resources and provide the selected resources to Alignment Module 162. A user may also create custom resources to be provided to Alignment Module 162 at step 440. Optionally, Alignment Module 162 may provide a recommended list of resources to a user or users, and the user or users may select resources from the list for inclusion in the selected resources. Alignment Module 162 may employ Interface 510 when interpreting resources at step 440.

For example, at step 440, Alignment Module 162 may search a centralized structure, such as a file server, for available resources. Alternatively, resources may be spread among different locations inside and outside an organization physical location, and Alignment Module 162 may search some or all of these locations. Alignment Module 162 may search a subset of resources based on the key areas, initiatives and priorities, and performance metrics identified in previous steps.

Examples of resources include, but are not limited to, spreadsheets, databases, checklists, diagrams, timelines, text files, and other data. Resources may be used to describe, for example, procedures, workflows, chain-of-command and responsible parties, cost data, information about assets available to an individual or organization, liabilities, personnel, or other data.

### IV. Knowledge Module

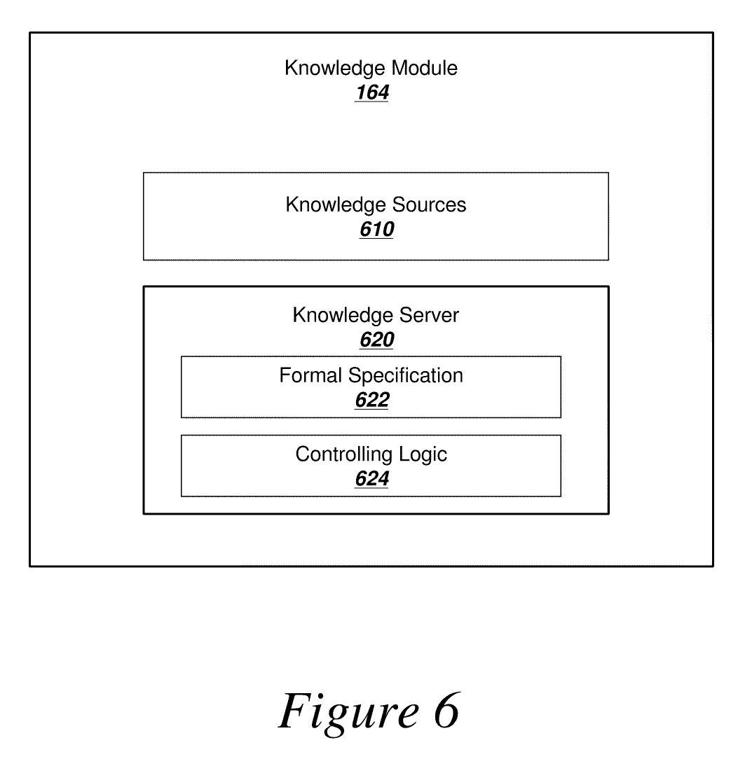

Exemplary embodiments may provide a Knowledge Module 164 that encapsulates and structures data identified in the Alignment Process 400. FIG. 6 illustrates a block diagram of an exemplary Knowledge Module 164. Knowledge Module 164 may include one or more Knowledge Sources 610, each of which is a repository of data. For example, knowledge sources in the domain of mining may include information on mines (e.g. location, size and grade of deposit), knowledge sources in the domain of business accounting may include information on business profitability (e.g. revenue, expenses, overhead for groups within a business), etc. Data Sources 312-318 are examples of Knowledge Sources 610.

Knowledge Sources 610 may be any type of data repository, e.g. databases, data files, etc. Knowledge Sources 610 may enable computerized collection, organization and retrieval of the data. To this end, Knowledge Sources 610 may have a computer-readable format such that a computer can automatically parse, organize and query the knowledge bases, with little or no input from a human user.

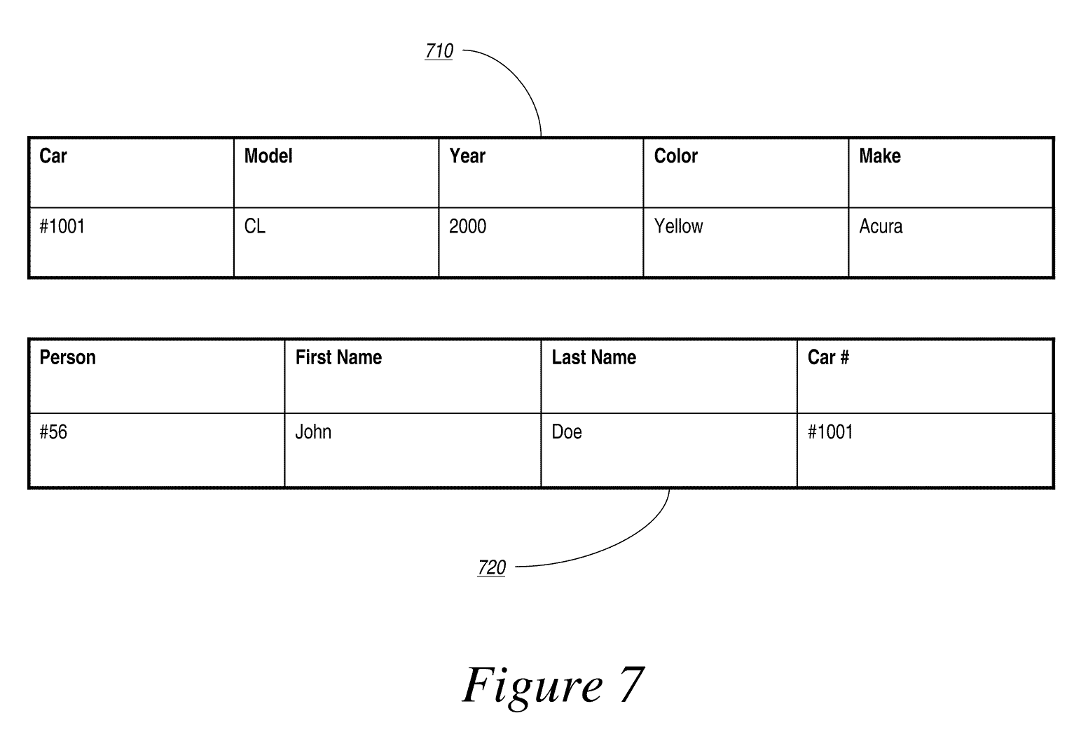

FIG. 7 illustrates two exemplary databases 710, 720 that may be included in the Knowledge Sources 610. In this example, each entry in database 710 includes a personal identification number, a name of a person, and a car identification number Each entry in database 720 includes a vehicle identification number, and the model, year, color and make of a vehicle.

In some exemplary embodiments, the Knowledge Sources 610 may include a single knowledge source, e.g. a single database. In other exemplary embodiments, the Knowledge Sources 610 may include two or more Knowledge Sources 610, e.g. multiple separate databases. In this case, Knowledge Sources 610 may provide links that enables access to objects in one source from another source, e.g. database links. The links may allow one Knowledge Source 610 to refer to tables and views on another Knowledge Source 610. Such links may allow relational interconnections among Knowledge Sources 610, which enhances the descriptive power of the Knowledge Sources 610.

In some exemplary embodiments, Knowledge Module 164 may automatically populate the Knowledge Sources 610 based on data provided Alignment Process 400. In other exemplary embodiments, Knowledge Module 164 may generate Knowledge Sources 610 based on user input. To this end, Knowledge Module 164 may provide one or more user interfaces which a user may use to specify data that should populate the Knowledge Sources 610. For example, the user may enter the entries of a database contained in the Knowledge Sources 610. In yet other exemplary embodiments, the Knowledge Module 164 may receive one or more pre-generated knowledge sources. These pre-generated knowledge sources may be specified by a user. In addition, Knowledge Sources 610 may be edited, added to or removed by the user at any time.

The Knowledge Module 164 may also include a Knowledge Server 620 which provides a Formal Specification 622 of data contained in Knowledge Sources 610. Formal Specification 622 may be a description of the concepts and relationships that exist in the data of Knowledge Sources 610. Knowledge Server 620 may also provide Controlling Logic 624 which provides rules to retrieve data from Formal Specification 622. Knowledge Server 620 may further provide one or more interfaces for querying Formal Specification 622.

In some exemplary embodiments, Formal Specification 622 may take the form of an ontology, which is a formal representation of a set of concepts within one or more domains of interest and the relationships between those concepts. An ontology may provide a shared vocabulary relevant to the user's domains of interest, which can be used to model the domains of interest using ontology classes/objects, properties and relationship. Examples of domains of interest include, but are not limited to, the domain of “gold mining” which may include concepts such as size of deposit, grade of ore, etc, and the domain of “natural knowledge processing” which may include concepts such as parts-of-speech tags, speech segments, etc.

In some exemplary embodiments, the ontology may provide a formal specification of data contained in a single Knowledge Source 610, e.g. a single SQL database. In other exemplary embodiments, the ontology may provide a formal specification of data contained in multiple Knowledge Sources 610, e.g. a database containing information on minerals and another database containing information on mines. Multiple Knowledge Sources 610 may cover more than one domains of knowledge, e.g. the separate domains of minerals and mines. By enlarging the scope of the ontology to encompass multiple domains of knowledge, exemplary embodiments may allow data retrieval inferences and deductions based on disparate domains. This enhances the information retrieval capability of the ontology, and allows a user of the ontology to make queries that require knowledge from multiple domains.

Common components of the ontology will now be described. The ontology provided by exemplary embodiments may include one or more classes which are sets, collections, concepts, types of objects, or kinds of things. Examples of classes include, but are not limited to, types of motor vehicles (e.g. station wagon, truck, motorcycle), types of wines (e.g. red, white), etc. The ontology may also include zero or more attributes associated with objects of each class. Attributes may be aspects, properties, features, characteristics, or parameters associated with the objects of each class. Examples of attributes include, but are not limited to, fuel efficiency of each type of motor vehicle, vintages and countries of origin of each type of wine, etc. The ontology may further include one or more relationships, each relationship relating two classes or two objects.

Controlling Logic 624 may enable operations to be performed on the contents of the ontology. Examples of such operations include, but are not limited to, searching, filtering and sorting. A searching operation may take a predefined search criterion, e.g. a predefined attribute, and retrieve all classes or class instances that satisfy the criterion. A filtering operation may take a set of classes or class instances, and filter out a subset that matches a predefined criterion, e.g. a predefined attribute. A sorting operation may take a set of classes or class instances, and sort the members of the set in a predefined order, e.g. in increasing values of a particular attribute.

Controlling Logic 624 of the ontology may include one or more axioms which are assertions that encapsulate a priori knowledge. In an exemplary embodiment, the axioms may take the form of rules written in a logical form. The ontology may also include one or more events which occur when attributes or relationships are changed in the ontology.

Controlling Logic 624 may support one or more automatic inferential or deductive operations that retrieve data from the ontology based on a user query. For example, the controlling logic may include one or more rules that describe logical inferences that may be drawn from an assertion in a particular form. The rules may be linked to each other to form complex chains of inferences. In an exemplary embodiment, the rules may take the form of if-then (antecedent-consequent) statements. The ability to perform automatic inferences means that users do not need domain expertise in order to retrieve information from the ontology.

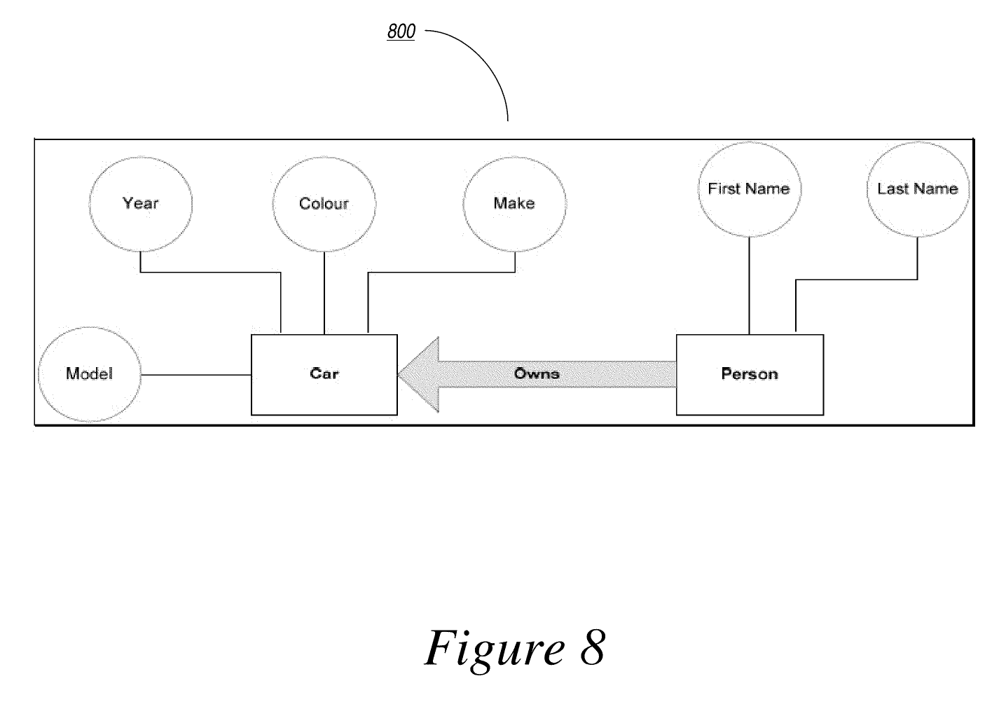

FIG. 8 illustrates an exemplary ontology 800 which has two classes (car, person). The car class includes four attributes (model, year, color, make), and the person class includes two attributes (first name, last name). A relationship between the classes, car and person, defines that a person owns a car or that a car is owned by a person.

One example of a query is a user retrieving car information on only yellow cars. This query may filter data on all cars by specifying that the color attribute must have a value of yellow. Another example of a query is a user retrieving the names of persons who own yellow cars. This query may use the result from the previous query, and determine which of those yellow cars have an “owned by” relationship. Then, the persons associated with such “owned by” relationships are determined, and their names are output.

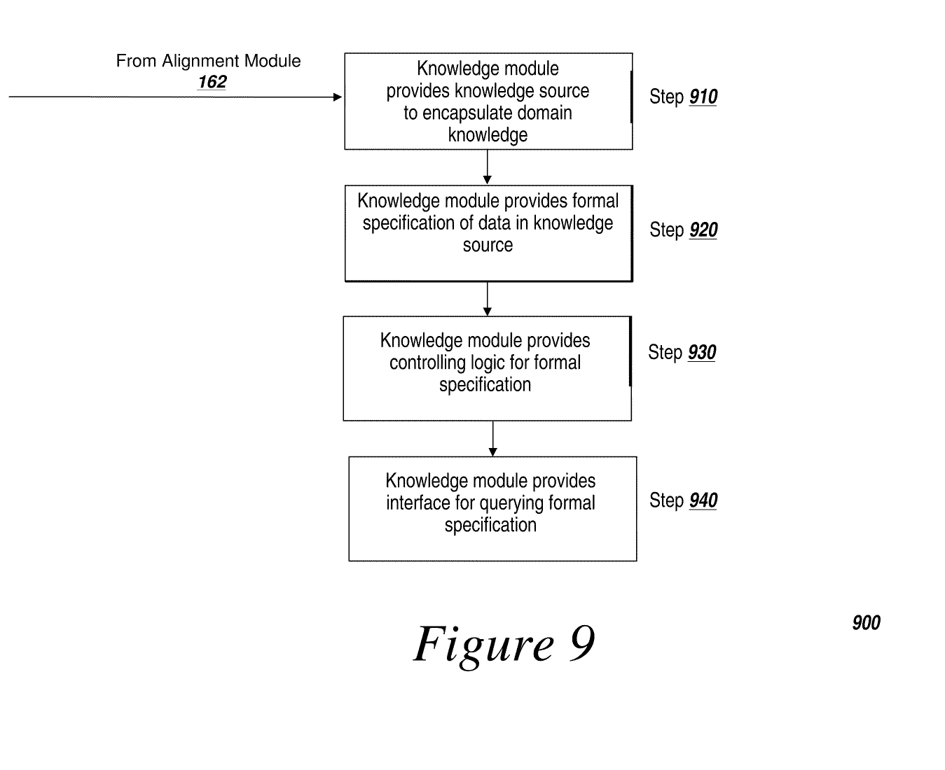

FIG. 9 illustrates a flowchart of Knowledge Process 900 including exemplary steps taken by the Knowledge Module 164 to provide Knowledge Sources 610 and Knowledge Server 620.

In step 910, Knowledge Module 164 may populate Knowledge Sources 610 with data or may be provided with populated Knowledge Sources 610. For example, in dealing with problems or questions in the domain of mining, Knowledge Sources 610 may be populated with data on available mines, properties of the mines, historical yields and profits associated with the mines, etc.

In step 920, exemplary embodiments may provide a Formal Specification 622 to define the concepts and relationships in the data contained in Knowledge Sources 610. In one exemplary embodiment, Formal Specification 622 may be an ontology. Creating the ontology may involve defining classes in the ontology, arranging the classes in a subclass-superclass hierarchy, defining attribute slots and allowed values for the slots, and filling in the slot values for instances of the classes.

In step 930, exemplary embodiments may provide Controlling Logic 624 to enable automatic querying of Formal Specification 622. For example, exemplary embodiments may provide one or more deductive and inferential rules that retrieve information from the formal specification pertinent to a query.

In step 940, exemplary embodiments may provide one or more interfaces to enable a human user or an external module or application to query Formal Specification 622. The user interface may allow the user to enter a query, and display a result of the query retrieved from Formal Specification 622. In an exemplary embodiment, the query may be a natural language query. In this case, exemplary embodiments may include a natural language processing module that is able to parse and semantically analyze the query. In another exemplary embodiment, the query may be a structured query that adheres to a particular format. In this case, exemplary embodiments may define the format of queries, e.g. by specifying syntax and semantics for the query format. Exemplary embodiments may determine a preferred query format based on the type of Formal Specification 622, and may restrict the user's query to the preferred format.

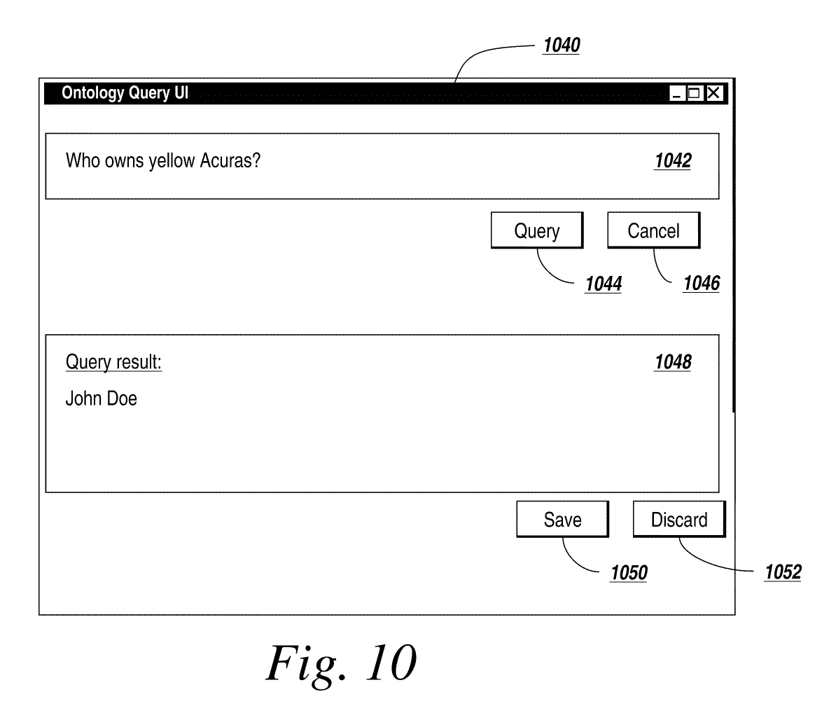

FIG. 10 illustrates an exemplary user interface 1040 that may be displayed to receive a query from a user and to display a query result to the user. In an exemplary embodiment, User Interface 1040 may include a text-box 1042 in which a user may enter a query. After entering a query, the user may select a “query” option 1044, e.g. provided in the form of a button, to query the formal specification and obtain a result. Otherwise, the user may select a “cancel” option 1046, e.g. provided in the form of a button, to cancel the query. User interface 1040 may also include a text panel 1048 that displays the results of the query. The user may select a “save” option 1050 to save the results of the query in a storage device, or a “discard” option 1052 to discard the results.

In another exemplary embodiment, user interface 1040 may provide a blank canvas and ontology components to allow the user to create a query formatted like an ontology.

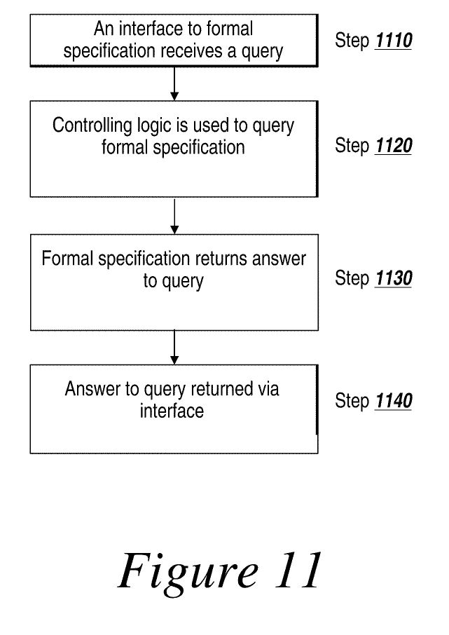

FIG. 11 illustrates a flowchart for exemplary steps taken in using Knowledge Server 620 to retrieve data.

In step 1110, an interface to Formal Specification 622 may receive a query. If the entity making the query is a human user, the interface may be a user interface which is displayed on a display device 130. An exemplary user interface is illustrated in FIG. 10. If the entity making the query is a computer module or application, the interface may be a protocol, convention or standard that controls the connection, communication and data transfer between the querying entity and Formal Specification 622.

In step 1120, Controlling Logic 624 may parse the query to determine what data is being requested. Controlling Logic 624 may then use deductive and inferential rules to determine one or more results to the query from the formal specification.

In step 1130, Formal Specification 622 may return the results to the query.

In step 1140, the results may be returned to the querying entity via the interface, e.g. by displaying on a user interface. An exemplary user interface is illustrated in FIG. 10. The querying entity may then use the results in making decisions, and store the results on a storage device.

### V. Encapsulation Module

Encapsulation Module 166 may accept an instruction to encapsulate relevant information, data, references, resources, and other inputs as a template, asset, or scenario.

An “asset” is an object that encapsulates a number of inputs that are associated with a particular decision. Assets may include the decision made, collaborations that went into making the decision, events that occurred during the decision making process, and other factors, which will be described in more detail below.

A “scenario” is an object that encapsulates an asset and provides context about the asset, such as the problem addressed by the asset, performance metrics for evaluating the asset, other scenarios that may be related to the current scenario, and controls that allow a user to take actions related to the scenario.

A “template” is a framework or skeleton for a scenario. A template may provide a starting point for developing a scenario.

Assets, templates, and scenarios may encapsulate decisions or resources useful for making a decision. Assets, templates, and scenarios may be used to make a decision, so that the resources encapsulated by the assets, templates, and scenarios represent resources useful during the decision making process. Alternatively, assets, templates, and scenarios may be assembled after a decision is made, such that a decision maker or another individual familiar with the decision assembles the resources encapsulated by the assets, templates, and scenarios based on which resources the decision-maker actually used in making the decision. In this way, institutional knowledge may be recorded and preserved for future review.

The instruction to encapsulate may be sent from another module in the asset framework to the Encapsulation Module 166, or may come from an outside source. For example, a user interacting with the Visualization and Storage Module 168 may define a scenario, and instructions to encapsulate the scenario may be sent from the Visualization and Storage Module 168 to the Encapsulation Module 166. In one embodiment, the Encapsulation Module 164 may generate the instruction, for example when the Encapsulation Module 164 determines that a template should be updated.

Encapsulation Module 164 identifies, acquires, interprets, and assembles inputs to be encapsulated and provides the encapsulated template, asset, or scenario to the other modules.

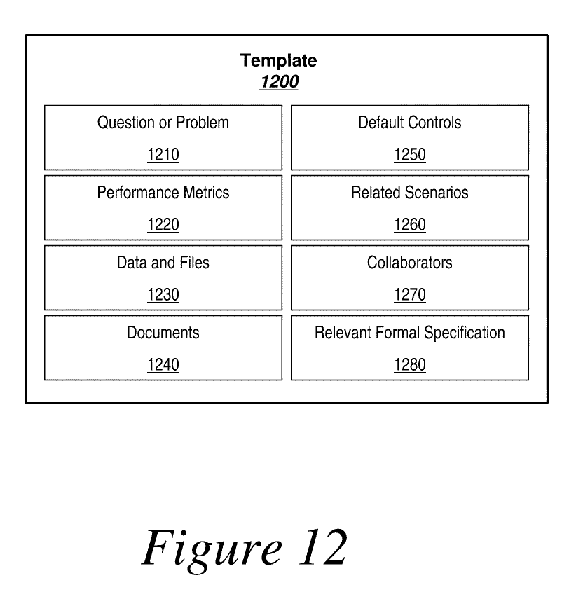

Encapsulation Module 164 may accept an instruction to encapsulate a template. FIG. 12 depicts and exemplary framework for a Template 1200 suitable for use in exemplary embodiments. Some or all of the components depicted in FIG. 12 may make up Template 1200.

Template 1200 is a framework or skeleton for a scenario. Template 1200 may provide, for example, basic elements that will be used in scenarios based on template 1200. The template 1200 may include, for example, a brief statement of a general question or problem 1210 addressed by the template. For example, Question or Problem 1210 may be “How to Hire a New Employee.” In this example, the template 1200 provides a general outline of procedures used in the hiring process, as well as resources available for use in the hiring process, collaborators that may be available to help with the decision, metrics that may be used in the evaluation of decisions about a potential employee, areas of the knowledge base that may be useful in the hiring process, and links to previous hiring decisions that have been made. Question or Problem 1210 may be provided by a user using the Visualization and Storage Module 168, or may be suggested by Encapsulation Module 166 based on other factors related to Template 1200. For example, based on data encapsulated by Template 1200, such as related scenarios, performance metrics, related documents, indicated relevant portions of the knowledge base, or other data, Encapsulation Module 166 may suggest a descriptive title, name, question, or problem for template 1200.

Template 1200 may be used to generate a scenario, which is a specific instance of the procedure, question, problem, or process described in the template 1200. In the above hiring process example, a scenario based on template 1200 might be, “Hiring a Computer Programmer for the Power Plant Facility Control Software Project.” Additionally, a scenario may be generated without at template 1200. If a new scenario is generated from scratch, relevant parts of the scenario may be saved as a new template for future use.

The components encapsulated by the template 1200 are referred to herein as “resources.” Resources include, but are not limited to information, documents, data, collaborations, collaborators, related scenarios, performance metrics and other assets that assist the decision-making process. In addition to the resources encapsulated by Template 1200, additional resources may be provided in a scenario, as described below.

Template 1200 may include Performance Metrics 1220 for evaluating potential answers, solutions, or outcomes related to Question or Problem 1210. Performance Metrics 1220 are described in more detail in relation to Alignment Module 162, above.

Template 1200 may also include Data or Files 1230 or Documents 1240 that may be useful in arriving at an answer, solution, or outcome related to Question or Problem 1210. Data or Files 1230 or Documents 1240 may be suggested by the Alignment Module 162 or Knowledge Module 164 based on the Question or Problem 1210, or other factors encapsulated by template 1200. Data or Files 1230 or Documents 1240 may also be provided by a user through Visualization and Storage Module 168.

For example, in the above-described example of a hiring process, a decision-maker may find it useful to have a flow chart providing an exemplary workflow, checklist, or procedure describing a hiring process. These workflows, checklists, or procedures may be provided as documents, such as word processing documents or spreadsheets, files such as computer-executable software, or data stored in the storage of an electronic device, such as electronic device 100.

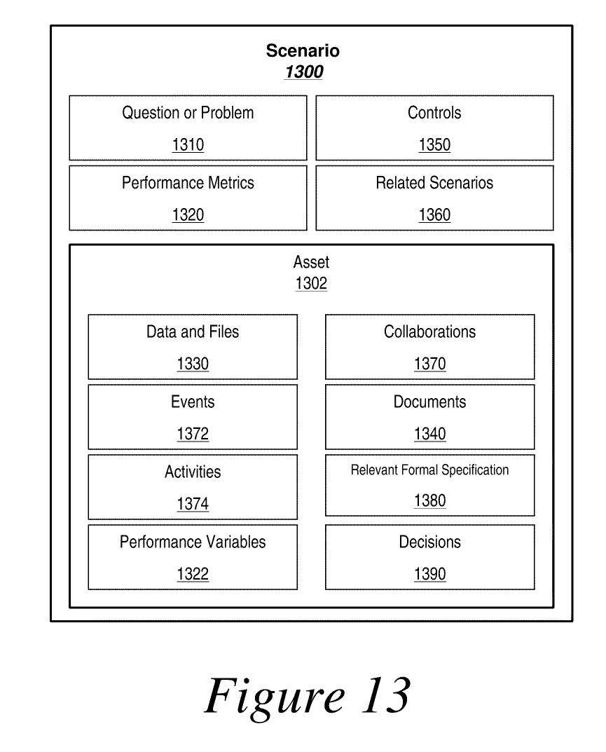

Template 1200 may include Collaborators 1270. Collaborators take part in Collaborations, such as discussions held between individuals that may contribute to a decision. Collaborations may take the form of memorandums, such as memorandums represented as word processing documents, emails between collaborators, audio or video recordings, meeting transcripts or minutes, or any other medium that may represent collaborations. In a scenario, the collaborations may be recorded (see, e.g., FIG. 13 depicting an exemplary scenario 1300). Often, in a template 1200, collaborations will not yet have taken place. Therefore, the template 1200 may identify individuals that should be consulted in the decision-making process.

Collaborations may indicate the collaborators who participated in a collaboration. Collaborators 1270 may include a number of individuals, each of whom may contribute to a collaboration in a different way or to a different degree. For example, an Accountable Party is a party who is accountable for a decision. In the hiring decision described above, the Accountable Party may be, for example, the head of the Human Resources Department. The Accountable Party, while ultimately accountable and answerable for a decision, may not be the person responsible for making the decision. If, for example, the human resources department is large and the head of the Department is able to delegate responsibility, the Responsible Party may be a subordinate who takes the initiative to make the decision. The Responsible Party may perform many of the tasks involved in decision making and may make the final decision. The Responsible Party may consult with other parties who contribute to the decision. Such Contributing Parties may contribute documents, suggestions, or other resources to the decision making process, which may or may not be reviewed by the Responsible or Accountable Parties. There may also be parties that do not take an active role in the decision, but wish to be informed about the decision or decision making process. Examples of Informed Parties might include, for example, the CEO of a company who is not directly involved in making a decision, but who may, for example, review the decision and decision-making process to ensure that a valid decision is made.

Template 1200 may further include default controls 1250. Controls 1250 are instructions that allow actions to be taken. For example, a control 1250, when executed, may provide a visualization of relevant data. A control 1250 may invoke collaboration, for example by providing a chat window or bulletin board interface that connects to other individuals. Controls 1250 may interact with other controls, for example a control in a first template or scenario may connect to a second template or scenario to update the second template or scenario when a decision is made with respect to the first template or scenario. Such a control may be useful, for example, if a second decision depends on the result of a first decision. Controls 1250 may provide filtering, for example filtering the Formal Specification 622 based on a keyword, metric, threshold, or other factor. One having ordinary skill in the art will understand that a control 1250 can be used to cause any action to occur, and is not limited to the above-described actions. Default controls may be provided with a template 1200, for example controls provided from a default library, or users may define custom controls.

Templates 1200 may encapsulate Associated or Related Scenarios 1260. Related Scenarios 1260 are scenarios that are related to the template 1200 in one or more ways. Related Scenarios 1260 may be related, for example, because the indicated Responsible Party in a Template 1200 is the same as the Responsible Party in a scenario stored in library 154. Other factors that indicate that an Related Scenario 1260 may be related to a template 1200 may include, for example, similar Questions or Problems 1210, similar Collaborators 1270, similar related Documents 1240 or Data and Files 1230, similar Performance Metrics 1220, or similar Controls 1250.

The degree to which a template, scenario, or asset is related to a template, scenario, or asset is referred to herein as “Affinity.” Two objects with a high affinity may be closely related, while two objects with a low affinity may be unrelated. The higher the affinity, the stronger the relationship. Encapsulation Module 166 may identify Related Scenarios 1260 by comparing Affinities against a default threshold. Alternatively, a user may define a custom threshold, or the user may manually specify Related Scenarios 1260. According to another embodiment, the Encapsulation Module 166 may suggest Related Scenarios 1260 to a user through Visualization and Storage Module 168, and a user may indicate which scenarios are relevant.

Template 1200 may also encapsulate a Relevant Portion 1280 of the Formal Specification 622. The Relevant Portion of the formal specification 1280 may include subsets of the formal specification 622 that may be useful in making a decision related to the template 1200. The Relevant Portion 1280 may be defined by a user interacting with the Encapsulation Module 166 through the Visualization and Storage Module 168, or may be automatically identified by the Encapsulation Module 166 or the Knowledge Module 164 based on other relevant factors encapsulated by Template 1200.

Template 1200 may be a default template provided in library 154, or may be defined by a user. As noted above, a scenario, which is a specific instantiation of a template, may be based on a template. Template 1200 may also be based on a scenario, for example by removing specific factors that might be relevant to a particular scenario but would not necessarily be relevant to other scenarios based on template 1200.

If a scenario is created based on a template 1200, this may indicate a high affinity between the scenario and template 1200, which may be taken into account when defining Related Scenarios 1260. If a scenario based on a template 1200 is changed, the template 1200 may be automatically updated to reflect the change. The updating may be performed by the Visualization and Storage Module 168 or the Encapsulation Module 166.

A scenario may be a specific instance of the procedure or problems described by a template 1200. A scenario may be created based on a template 1200, or may be defined from scratch by a user. A scenario may be defined through the Visualization and Storage Module 168. Alternatively, default scenarios may be provided in library 154.

As depicted in FIG. 13, scenario 1300 may encapsulate an asset 1302 which represents the final decision made 1390 and the particular resources used to make the decision. In addition to the asset 1302, Scenario 1300 may include a Question or Problem 1310, which may be a specific instance of the question or problem described in Template 1200. Scenario 1300 may further include Performance Metrics 1320, Controls 1350, and Related Scenarios 1360, as described above in relation to Template 1200. These resources may be described in further detail in relation to the specific Question or Problem 1310 encapsulated by the Scenario 1300. These resources, which may or may not be part of Asset 1302 may provide context for the decision 1390 made.

The resources encapsulated by Asset 1302, such as Data and Files 1330, Documents 1340, and a Relevant Portion of the Formal Specification 1380 may be similar to their respective counterparts in the Template 1200. These resources may be further refined and augmented by providing details relevant to the particular Problem or Question 1310 encapsulated by the Scenario 1300. Collaborations 1370 may be related to the above-described Collaborators 1270, and may include the discussions, meetings, conferences, or other interactions between Collaborators 1270 or other collaborators.

Performance Variables 1322 may be related to Performance Metrics 1320, and may include the parameters by which a decision is evaluated. For example, if the decision is related to the acquisition of heavy equipment, Performance Variables 1322 might reflect the cost of the equipment acquired, while Performance Metrics 1320 might represent the budget for the equipment.

Further, Events 1372 or Activities 1374 may be provided as part of the Asset 1302. Events 1372 and activities 1374 represent events and activities that occur during the decision making process. Events 1372 may be related to the Decision 1390 or the Question or Problem 1310 (e.g., in the hiring scenario, Events 172 might include “Unemployment fell to 3%”), or may be appear to be unrelated to the Decision 1390 or the Question or Problem 1310. Events 1372 may be automatically recorded by the Visualization and Storage Module 168, the Encapsulation Module 166, or the Knowledge Module 164. For example, the Knowledge Module 164 may include a representation of a stock market, and during a decision-making process related to stocks, may identify relevant events and automatically include them among Events 1372. Alternatively, Events 1372 may be entered by a user through the Visualization and Storage Module 168. Activities 1374 may be reflect, for example, ongoing events, processes, or procedures.

Decision 1390 may reflect the decision made based on the available information, or an outcome related to the Question or Problem 1310 posed. Decision 1390 may be defined manually through Visualization and Storage Module 168, or may be automatically updated, for example based on changes made to Formal Specification 622 or underlying Knowledge Sources 610. Further, the decision may be reflected in Formal Specification 622 automatically by interaction between Encapsulation Module 166 and Knowledge Module 164.

A scenario 1300 may include multiple assets 1302. For example, a single scenario 1300 may require multiple decisions. Multiple assets 1302 may also be used to reflect different alternative decisions that may be made based on the Question or Problem 1310. Controls 1350 may allow a user to “execute” a decision by simulating different decision outcomes made based on the available resources. Such a control 1350 may provide, for example, Performance Variables 1322 that the Encapsulation Module 166 or Knowledge Module 164 estimates would result from the simulated decision. Performance Variables 1322 may also be estimated by a user and entered through an interface in Visualization and Storage Module 168. Alternatively, estimated Performance Variables 168 may be generated by the Encapsulation Module 166 or the Knowledge Module 164. For example, Knowledge Module 164 may provide information, such as cost information, related to a simulated outcome. The estimated Performance Variables 1322 may also be acquired from outside sources, such as the Internet. Simulated Performance Variables 1322 may be evaluated against Performance Metrics 1320 encapsulated by Scenario 1300 in order to determine how good or bad a simulated outcome is.

### VI. Visualization and Storage Module

Visualization and Storage Module 168 provides an integrated approach to viewing and using controls, scenarios and assets. Functionalities provided by Visualization and Storage Module 168 include, but are not limited to, providing access to existing controls, scenarios and assets, allowing a user to create and store the aforementioned components, displaying information encapsulated by these components, and allowing collaboration among users. In addition, Visualization and Storage Module 168 may store controls, templates, assets, and scenarios in a library, such as library 154.

In an exemplary embodiment, Visualization and Storage Module 168 may provide these functionalities using a graphical user interface (GUI). The GUI and graphical components of the GUI may be implemented using Windows Presentation Foundation (WPF), a graphical subsystem established in .NET Framework 3.0. WPF uses Extensible Application Markup Language (XAML), a markup language, for rich user interface development. WPF allows Visualization and Storage Module 168 to clearly separate the GUI from underlying logical operations, e.g. ontological inferences, provided in exemplary embodiments to facilitate decision-making.

The GUI may be displayed on a display device, e.g. a computer screen. The display device may allow a user to interact with the GUI via touch, e.g. using a stylus pen or a finger. The user may also interact with the GUI using other input devices, e.g. a mouse and/or keyboard.

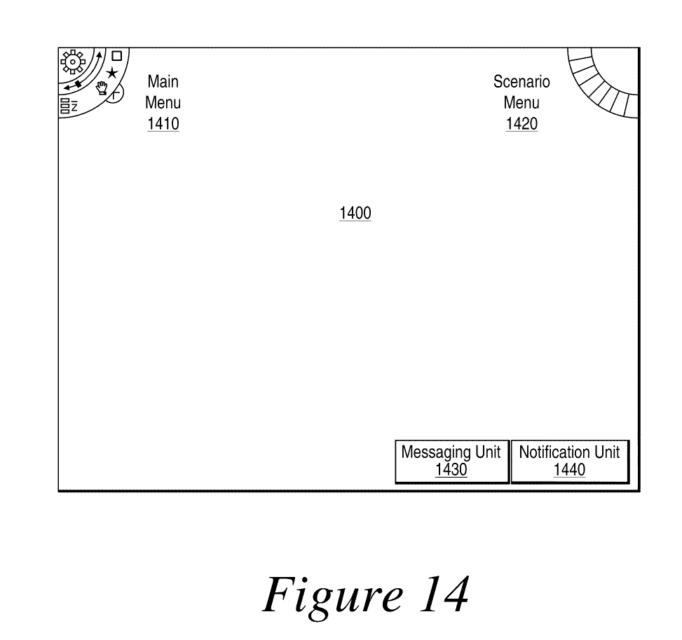

FIG. 14 illustrates an exemplary GUI 1400 provided by Visualization and Storage Module 168 for display on a Display Device 130. The GUI 1400 may include a Main Menu 1410, a Scenario Menu 1420, a Messaging Unit 1430, and a Notification Unit 1440.

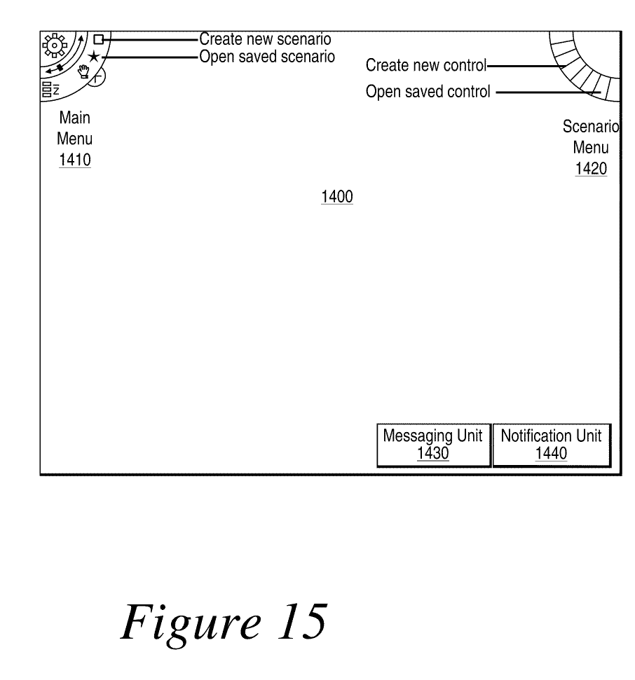

The Main Menu 1410 may expose, in its menu-items, “global” functionality that is always accessible by a user in GUI 1400. Examples of global functionality include, but are not limited to, creating a new scenario and accessing a saved scenario. Global functionality may also include options for navigating among multiple open scenarios, undo/redo options for undoing/redoing the last user action or the last change in information, and a zoom level slider for zooming in/out on a portion of the GUI 1400. Global functionality may further include a global settings option, which includes user information (e.g. identification of the current user), navigation style (e.g. mouse, single-touch, multi-touch), bug reporting, etc. These exemplary menu-items are shown in the exemplary main menu 1410 of FIG. 15.

In an exemplary embodiment, Main Menu 1410 may be a radius-type menu, for example located in the upper left hand corner of the GUI 1400. Radius menus are typically unobtrusive and leave sufficient room on the screen for the menu to expand. The Main Menu 1410 may support collapsing into the upper left hand corner where a visual cue remains, as illustrated in FIG. 14. When in use, the Main Menu 1410 may expand radially to display the menu-items.

Scenario Menu 1420 may expose, in its menu-items, functionality specific to a current scenario. Examples of scenario-specific functionality include, but are not limited to, creating a new control, using and configuring a saved control, entering information associated with a control, etc. These exemplary menu-items are shown in the exemplary Scenario Menu 1420 of FIG. 15.

Scenario Menu 1420 may be a radius menu, for example located in the upper right hand corner of the GUI 1400. When there is no active scenario, Scenario Menu 1420 may disappear. Like Main Menu 1410, Scenario Menu 1420 may be collapsible with a visual cue left for the user to expand the menu back to its original size.

GUI 1400 may include a persistent Messaging Unit 1430, e.g. located at the bottom right of the GUI 1400. Messaging Unit 1430 allows collaboration between two or more users. A collaboration among users may involve more than one user making changes to a scenario. To maintain consistency in the changes made by the different users, exemplary embodiments may provide version control functionality to manage multiple revisions of the same scenario. A collaboration may also involve communications among the users.

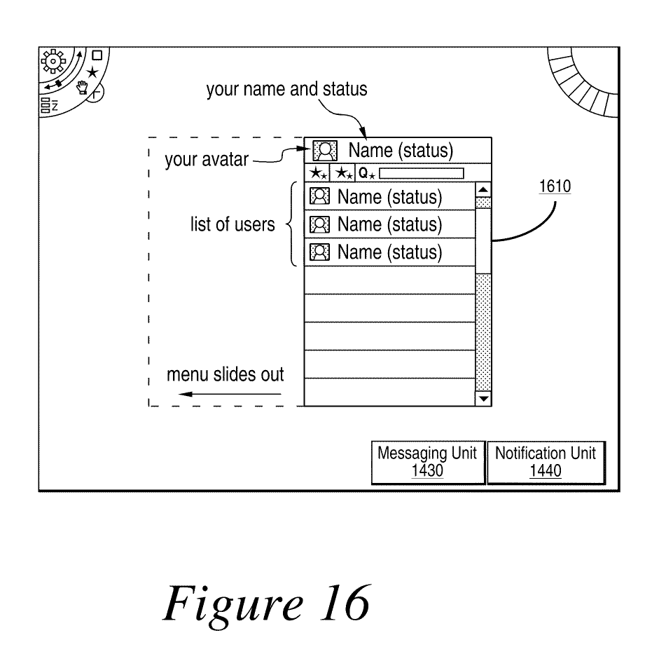

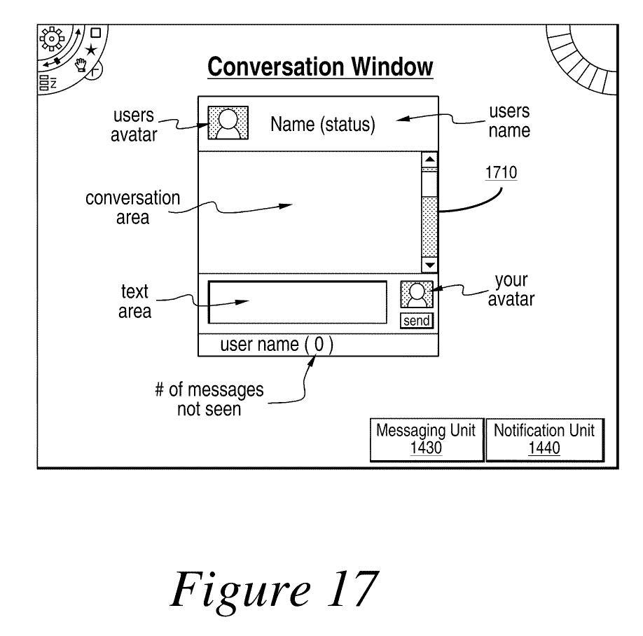

FIGS. 16-17 show an online collaboration option that takes the form of a Conversation Window 1710 associated with Messaging Unit 1430. A user may initiate collaboration with other users using different options, e.g. by hovering the mouse icon over or clicking the Messaging Unit 1430. This action displays a GUI element 1610, e.g. a menu, that shows the name, avatar, and current status (e.g. online, offline) of different users of the GUI. A current user may select one of the other user entries in the GUI element to indicate that the current user wishes to begin collaborating with the user of that entry. If the latter user is offline, i.e. not currently using the system, the GUI element may provide an offline collaboration option, e.g. email, telephone, message board, etc. However, if the user is online, the GUI element may provide an online collaboration option, e.g. chat room, messaging, etc.

Conversation Window 1710 may include a conversation area in which messages from two or more collaborating users may be presented. The conversation may include back and forth dialog with timestamps. Conversation Window 1710 may also include a text area in which the current user may enter messages. Conversation Window 1710 may include a “send” option which transmits the message entered in the text area to the collaborating user's conversation area.

A conversation in the conversation window may begin as a two-person conversation: the current user and someone else. Subsequently, it is possible for either the current user or the other user in the conversation to invite other people into the conversation. Multiple Conversation Windows 1710 may be open, e.g. for the current user's conversations with different people.

After encapsulating a collaboration, the messaging unit may save the collaboration (e.g. the chat log, email, message) and meta-data associated with collaboration (e.g. the names of the collaborators, time of the collaboration), etc on a storage device. The messaging unit may further provide an archive of saved collaborations that a user may browse to view saved collaborations and associated meta-data. The user may also add saved collaborations into a Scenario 1300.

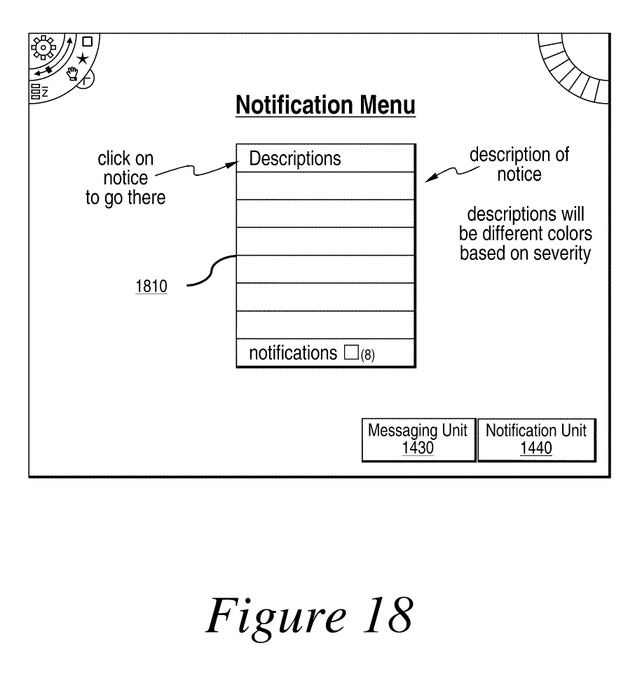

The GUI 1400 may include a persistent Notification Unit 1440, e.g. located at the bottom right of GUI 1400. Notification Unit 1440 may provide notifications about changes in the GUI 1400 that may interest the current user. Notification Unit 1440 may present the notifications in a Notification Menu 1810, illustrated in FIG. 18, which includes a list of notifications. The user may select an entry in the notification list to navigate to the item associated with the notification. For example, if the notification relates to a change in a Scenario 1300, selecting the entry may open up the Scenario 1300.

Selecting the entry may also indicate the portion of the scenario that was changed by displaying the portion in a different appearance, e.g. in a glowing box, in a different color, etc. This different appearance may server as a notification indicator that notifies the user that something has changed. The notification indicator may also include a severity that indicates the extent of the change, e.g. severe changes, light changes.

The GUI 1400 provided by Visualization and Storage Module 168 may include one or more controls. As described above, a control may be an atomic building block of a scenario, and may denote an action taken by a user in the process of making a decision. In exemplary embodiments, controls may be implemented in the C# programming language.

Visualization and Storage Module 168 may provide an application programming interface (API) to enable third-party software to develop controls for subsequent inclusion in new or existing scenarios. The API may include programming interfaces that enable creation and use of controls, and standards that specify features of controls (e.g. configuration of the connections of the controls). The API may also include technical documentation and user manuals for the controls, and examples of the creation and use of the controls.

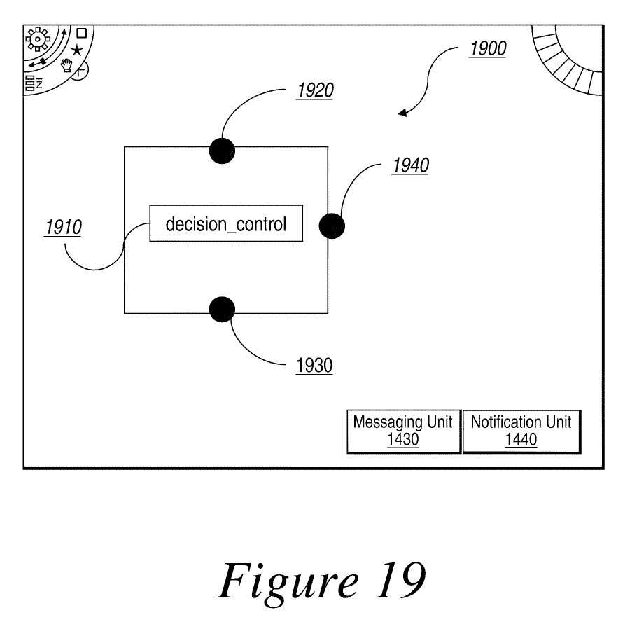

GUI 1400 may display a control in different ways including, but not limited to, as a symbolic element (like an icon or a block), as a GUI element (like a mini-GUI within GUI 1400), etc. FIG. 19 illustrates an exemplary control 1900 in which the control is embodied as a block.

Control 1900 may include a name 1910, which provides a descriptive tag for the control.

Control 1900 may provide one or more Input Connections 1920 to one or more data sources, such as data sources 312-318. Input Connections 1920 may allow Control 1900 to access the data sources, send queries to the data sources, and retrieve information from the data sources. Control 1900 may display the information retrieved from the data sources to facilitate a user in performing an action in a decision-making process.

Control 1900 may also provide one or more Output Connections 1930 to a data visualizer. Data visualizers may enable the display of data. For example, data may be output into a file or onto paper by a printing device. Data may also be displayed within a display of the data visualizer in GUI 1400 on a display device 130. Output Connections 1930 may allow Control 1900 to display any data or information received at its input connections 1920. The display of the data may allow a user to gain a clear understanding of the implications of the data, and may facilitate in decision-making.

Control 1900 may further provide one or more control connections 1940 to one or more other controls. Control Connections 1940 may enable a user to connect Control 1900 to one or more other controls, e.g. in a scenario. Connecting multiple controls may allow a user to combine data retrieved by the controls, and display the combined data in a single presentation. Thus, Control Connections 1940 may allow a user to automatically gather data from different, often disparate sources, and to present meaningful displays of a combination of different types of data.

Controls may also be connected and grouped together so that selecting an item in one control highlights or filters data appropriately in one or more other controls. For example, a first control may show a data grid of oil wells in Northern Alberta, and a second control may show a map of oil wells in Northern Alberta. Selecting a well in the data grid of the first control highlights the associated well on the map of the second control.

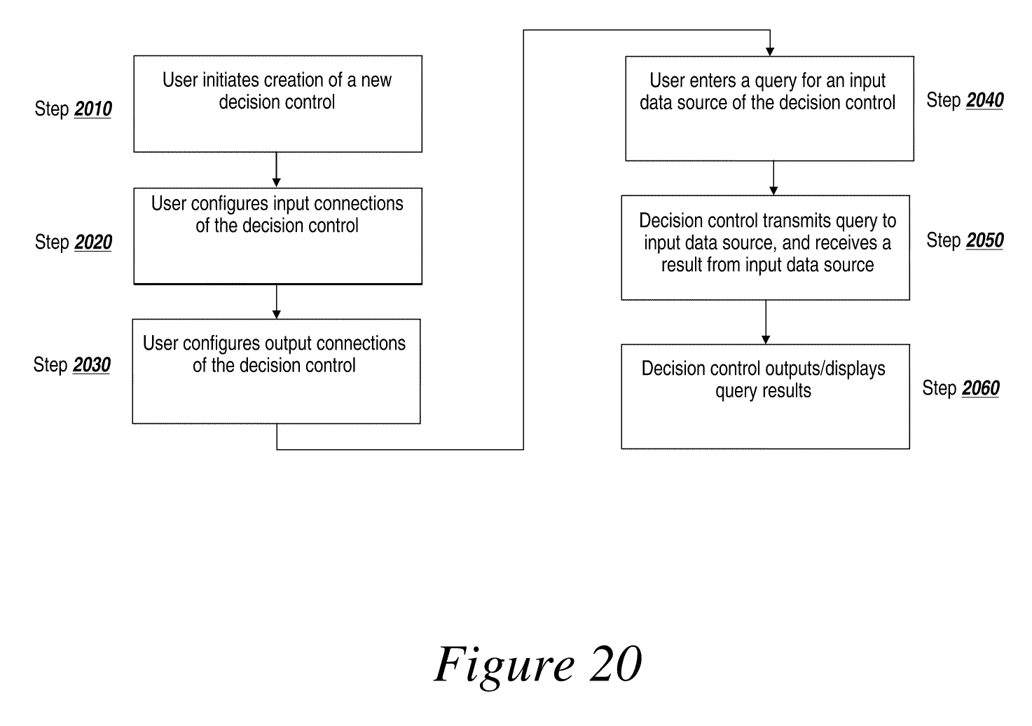

FIG. 20 illustrates an exemplary flowchart for creating and using a control in a scenario. Controls are the building blocks of scenarios. A user will thus need to create a new scenario or open a saved scenario, before creating a new control in the scenario.

In step 2010, a user may select the “new control” menu-option in the scenario menu 1420 of the GUI 1400 to create a new control 1900. Alternatively, the user may use other options to create a new control, e.g. using keyboard shortcuts. In response, Visualization and Storage Module 168 may provide a user interface to allow the user enter a name and a description for the new control. Visualization and Storage Module 168 may then display the new control in the GUI 1400.

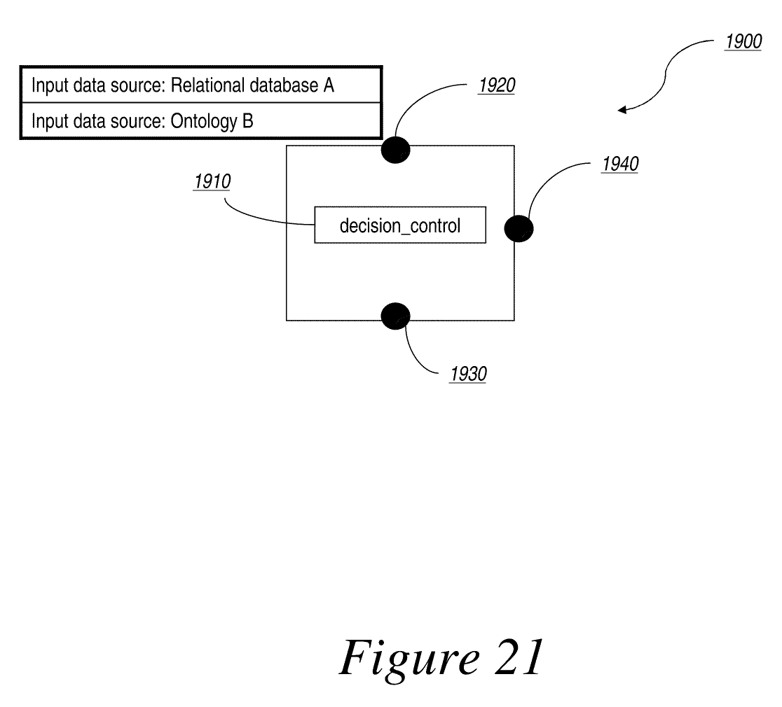

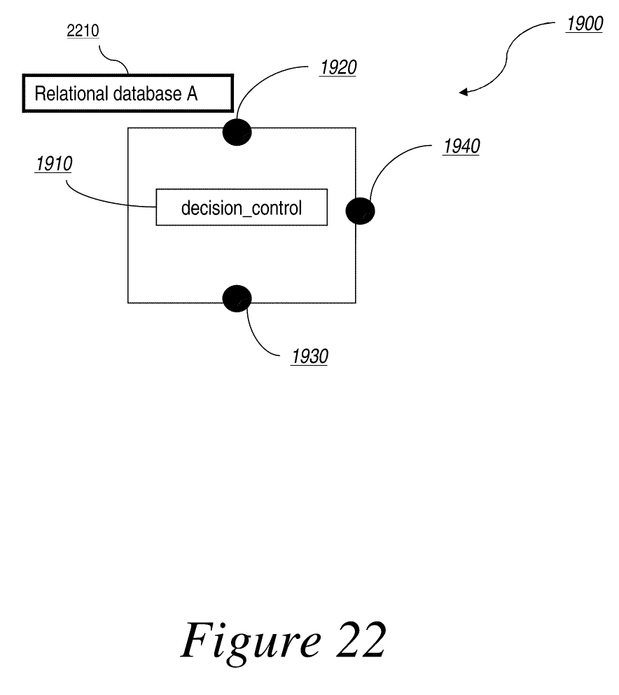

In step 2020, the user may configure the input connections 1920 of the control, i.e. the user may specify data sources from which the control may retrieve data. FIGS. 21-22 illustrates an exemplary process of configuring an input connection 1920. The user may invoke this configuration functionality using different options, e.g. by clicking on or hovering the mouse icon over the input connection 1920. Upon selection of this option, Visualization and Storage Module 168 may automatically present a list of available data sources that may be connected to the control. FIG. 21 illustrates an exemplary list 2110 presented for Input Connection 1920. The user may select one or more data sources shown in List 2110 to configure Input Connection 1920 of control 1900. Subsequently, Input Connection 1920 may change its appearance to indicate the input data sources connected to the control. FIG. 22 illustrates the input connection 1920 of FIG. 21 after configuration, in which Input Connection 1920 is associated with a name 2210 of a selected input data source.

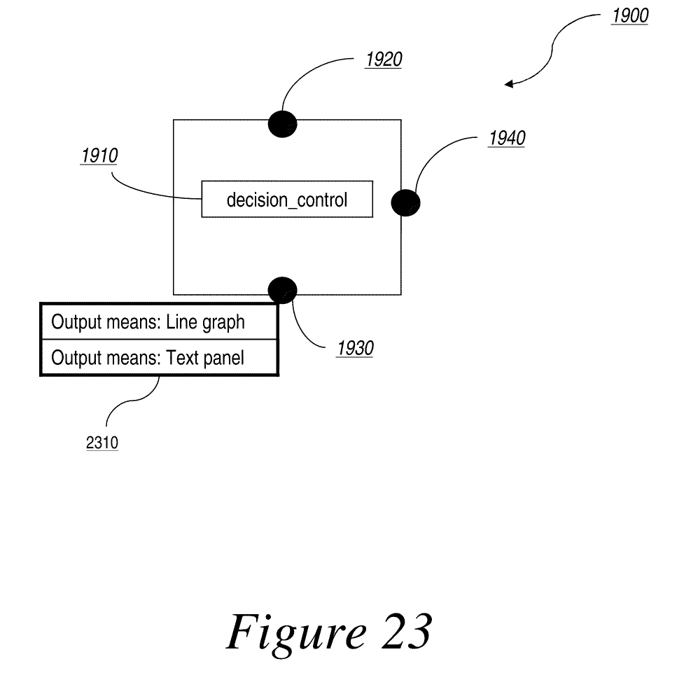

In step 2030, the user may configure the output connections 1930 of the control, i.e. specify configuration of the data visualizer for output of retrieved data. FIGS. 23-34 illustrate an exemplary process of configuring an output connection 1930. The user may invoke this configuration functionality using different options, e.g. by clicking on or hovering the mouse icon over the output connection 1930. Upon selection of this option, Visualization and Storage Module 168 may automatically present a list of available types of data visualizers, e.g. different types of graphs, an output file, a text panel, etc. FIG. 23 illustrates an exemplary list 2310 presented for Output Connection 1930. The data visualizers that are available for configuration may depend on the type of data sources connected to Input Connection 1920. As an example, if the control is configured to retrieve data from a relational database, the data visualizer may be a table of entries or a graph that shows data from the database. As another example, if the control is configured to retrieve data from an ontology, the data visualizer may be a text panel that displays the result of an ontology query.

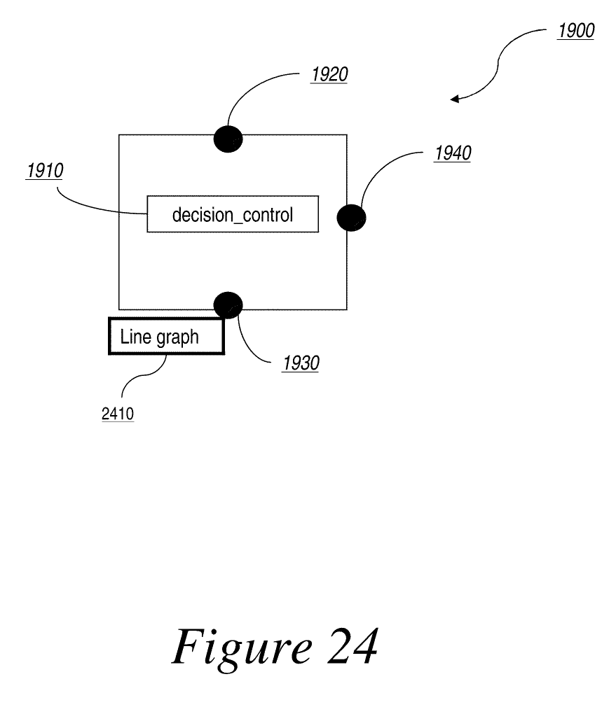

The user may select one or more data visualizers shown in the list 2310 to configure the Output Connection 1930 of the control. Subsequently, Output Connection 1930 may change in appearance to display the selected data visualizer. In an exemplary embodiment, the data visualizer may be provided within the display of Control 1900. In another exemplary embodiment, the data visualizer may be provided outside the display of Control 1900, e.g. in a separate GUI pane. FIG. 24 illustrates the output connection of FIG. 23 after configuration, in which Output Connection 1930 is associated with the display of a graph 2410.

In step 2040, the user may enter a query for an input data source of the control, i.e. the user may request data from an input data source. The user may invoke this query functionality using different options, e.g. by clicking on or hovering the mouse icon over a name of an input data source 2210. Upon selection of this option, Visualization and Storage Module 168 may present a user interface, e.g. a text-box, in which the user may enter a query. In an exemplary embodiment, the user interface may present a blank space for entering the query. In another exemplary embodiment, the user interface may automatically present a preferred format for the query. This preferred format may be based on the type of the input data source. For example, for a relational database, the user interface may present a SQL format for the query.

Alternatively, the control may query an input data source automatically, e.g. based on a stored query.

In step 2050, the control may transmit the query to the input data source and receive one or more results from the input data source. To this end, the control may directly query the input data source. In another exemplary embodiment, the control may also implement and employ an interface to communicate with certain data sources. For example, if a user query does not conform to the format accepted by a data source, the interface may use wrapper functions to convert the user query to an acceptable format before transmitting the query to the data source. Similarly, if a result of a query does not conform to the format of result accepted by the control, the interface may use wrapper functions to convert the result to an acceptable format before displaying the result to the user.

In step 2060, the control may output query results (e.g. a query result from an ontology) or portions of the input data source (e.g. entries from a relational database) in the data visualizer to aid the user in a decision-making process.

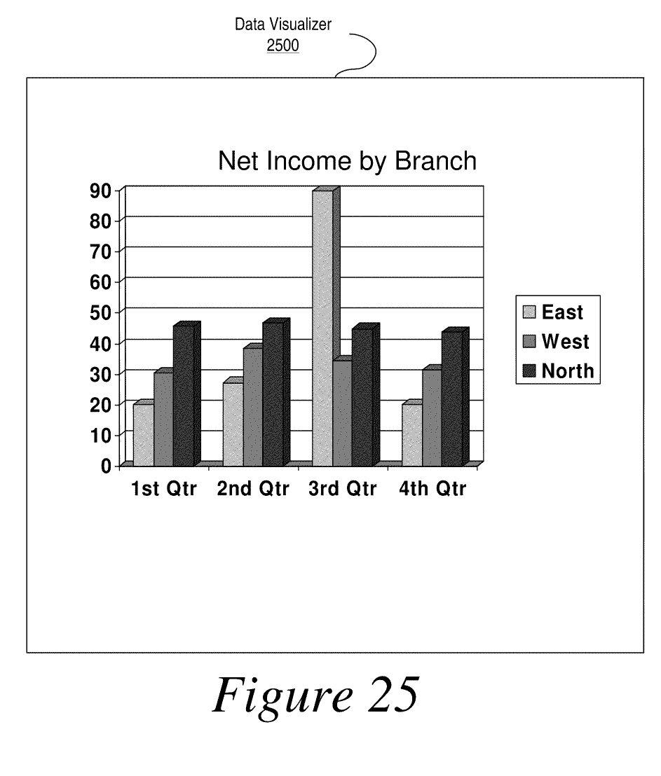

FIG. 25 shows Data Visualizer 2500 of an exemplary control. The control may retrieve data on quarterly income of the three branches (East, West, North) of a company. The data visualizer of the control may, for example, display the quarterly income data in a bar graph.

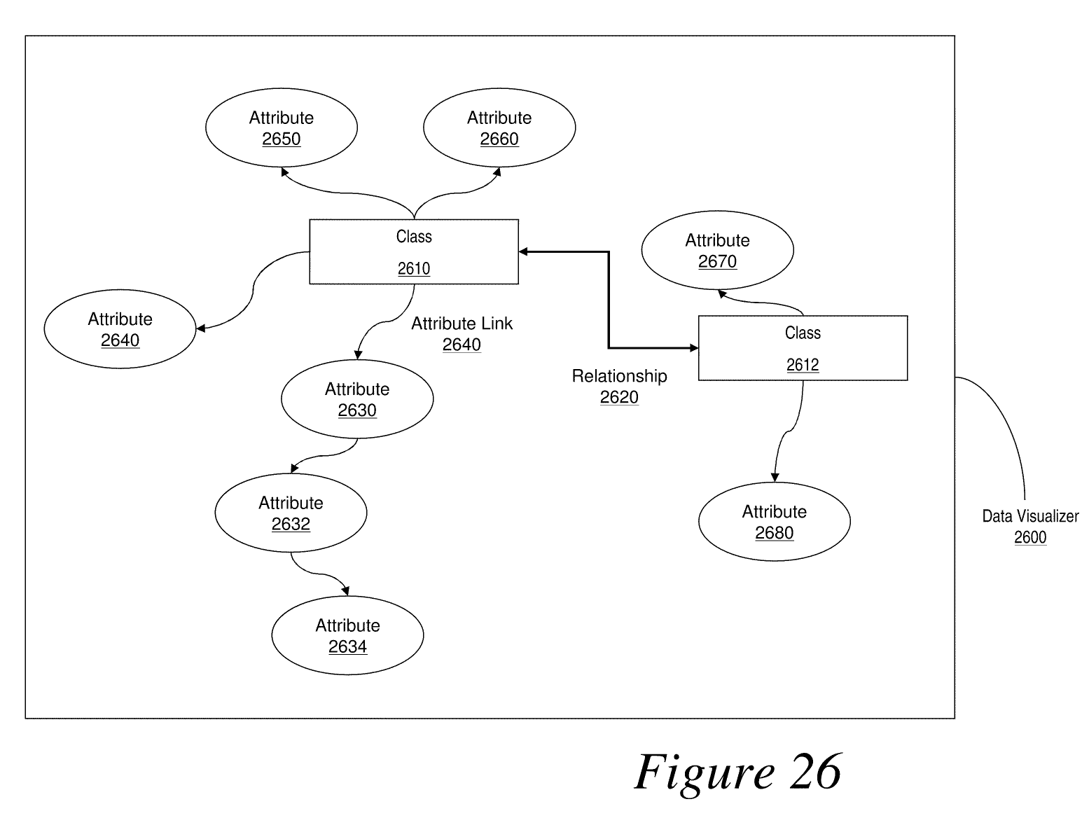

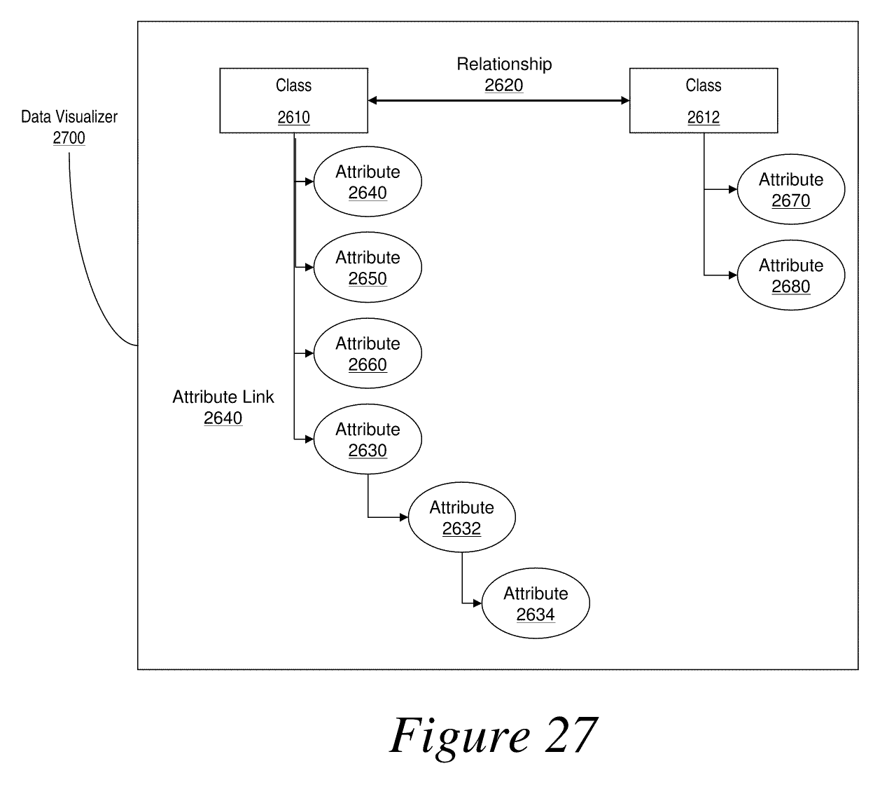

As depicted in FIGS. 26-27, the data visualizer may be used to create or edit an ontology and/or to display an ontology from an input data source. The data visualizer may allow the user to create an ontology by providing graphical elements for the different components of an ontology, e.g. classes 2610, 2612, attributes 2630, 2632, 2634, 2640, 2650, 2660, 2870, 2680, and relationships 2620. The user may drag and drop these components into the data visualizer to create the ontology. FIG. 26 illustrates a data visualizer display 2600 of an ontology.

The data visualizer may also provide options for displaying and editing an existing ontology by adding, deleted, moving components in the ontology. A user may edit an ontology by, for example, adding or deleting classes, class attributes, relationships.

The data visualizer may include a zoom in/out feature which allows the user to zoom into a smaller portion of the ontology or to zoom out to a larger area.

The data visualizer may also allow the user to flatten the ontology of FIG. 26, as illustrated in FIG. 27. FIG. 27 depicts an alternate data visualizer representation 2700 of the same ontology as in FIG. 26

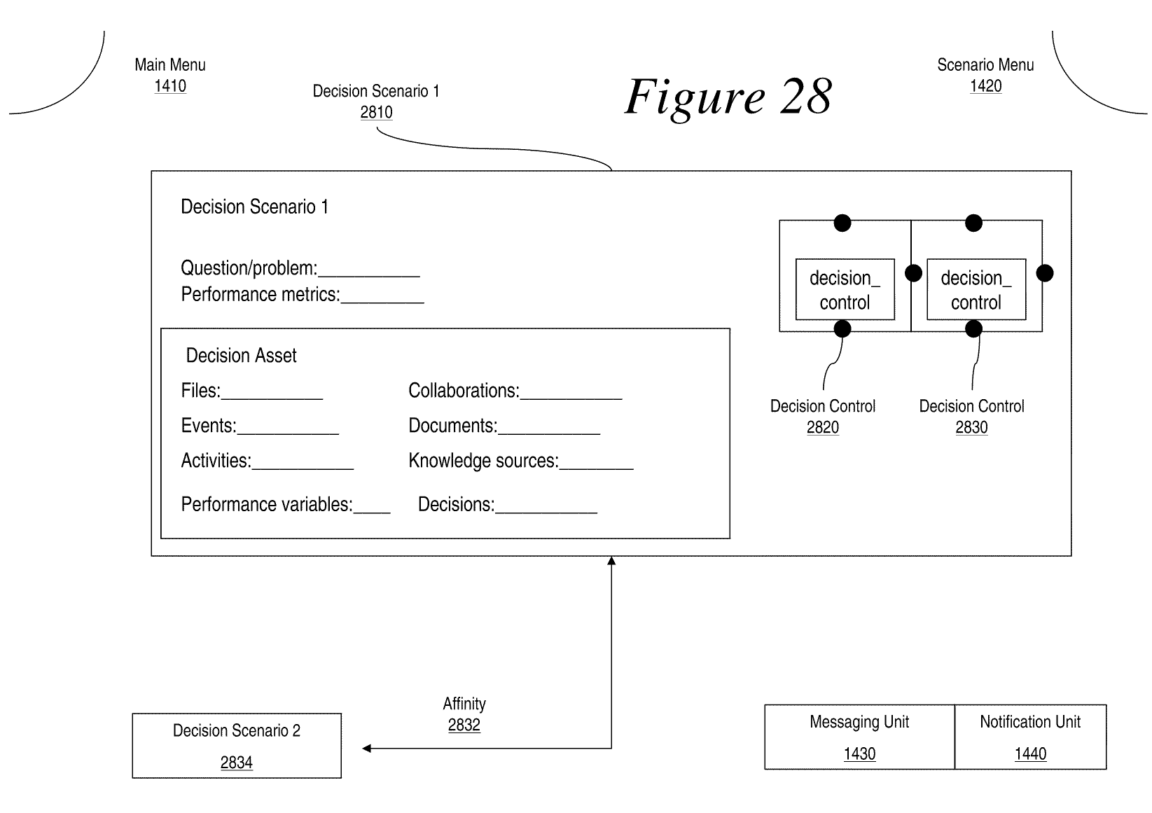

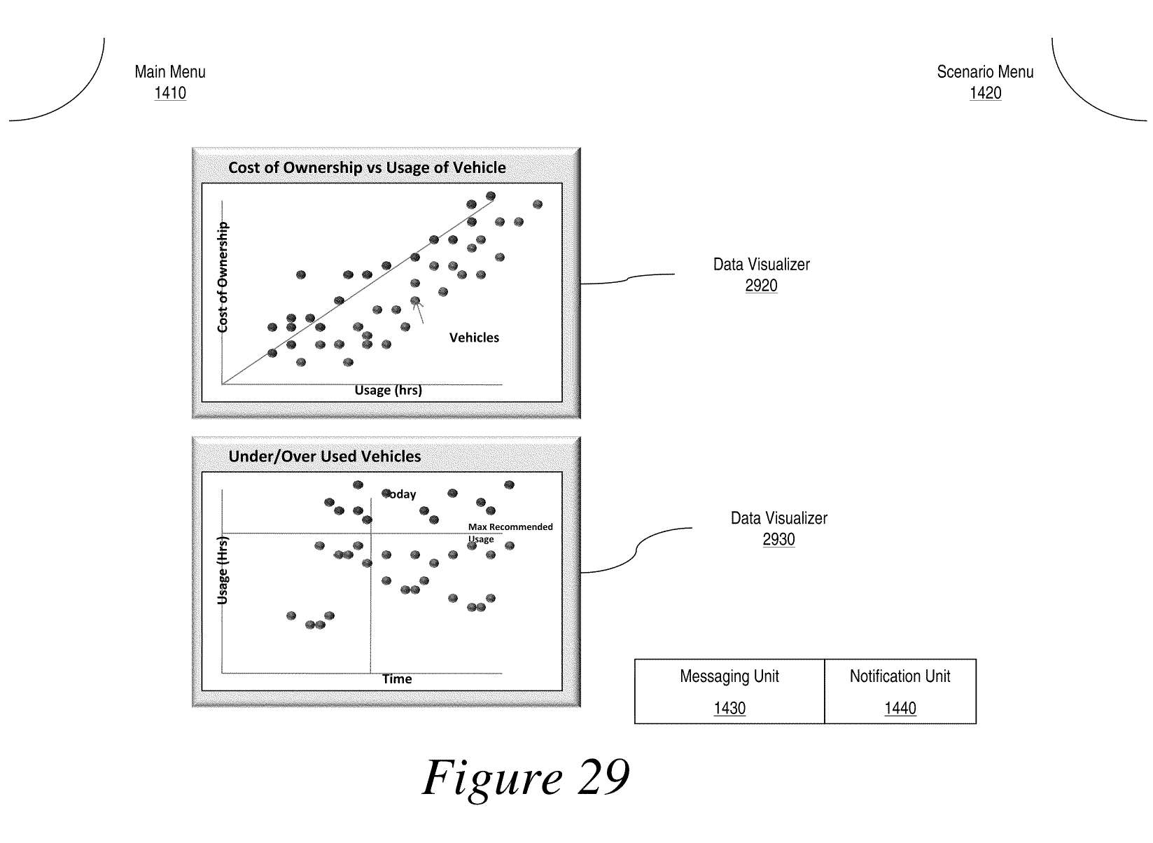

GUI 1400 provided by Visualization and Storage Module 168 may include one or more scenarios. In exemplary embodiments, the scenarios may be implemented in the C# programming language. FIG. 28 illustrates an exemplary Scenario 2810 named “Decision Scenario 1.” FIG. 29 depicts an example of data display in Scenario 2810. In this example, Scenario 2810 is created by a business entity to analyze the health of its fleet of vehicles. Scenario 2810 includes two controls 2820, 2830 pertaining to the health of the vehicles. Controls 2820, 2830 display data visualizations 2920, 2930, respectively, in Scenario 2810.

Control 2820 displays a scatter plot of the vehicles in the fleet along a y-axis representing the cost of ownership of each vehicle, and an x-axis representing the usage of each vehicle. This data visualization provided by Control 2820 allows the business entity to understand the cost of ownership of each vehicle relative to how much the vehicle costs. The data visualization is also helpful in identifying the vehicles that cost too much for their usage, and vehicles that could be used more.

Control 2830 displays a scatter plot of the vehicles in the fleet along a y-axis representing usage of each vehicle, and an x-axis representing the maximum recommended usage of each vehicle. This data visualization provided by Control 2830 allows the business entity to determine the utilization of the vehicles in the fleet. The data visualization also helps the business entity in identifying under-utilized assets, and in optimizing the utilization of the vehicles.

The exemplary scenario 2810 may be related to another scenario 2834 by an affinity 2832.

A user may open one or more saved scenarios in GUI 1400. The user may open a saved scenario by selecting the “open scenario” option in the main menu 1410. This option may provide the user with a list of scenarios that they user is allowed to access.

In one example, GUI 1400 may provide a user access to all the scenarios saved in the system. That is, the user may be able to select and use any of the scenarios. In another example, GUI 1400 may provide the user access to only the scenarios owned by the current user. In yet another example, GUI 1400 may provide the user access only to scenarios to which the current user has been invited or on which the user's team is working.

The user may browse and analyze the information in the saved scenario. The user may also edit the information in the saved scenario if the user has write-access to the scenario.

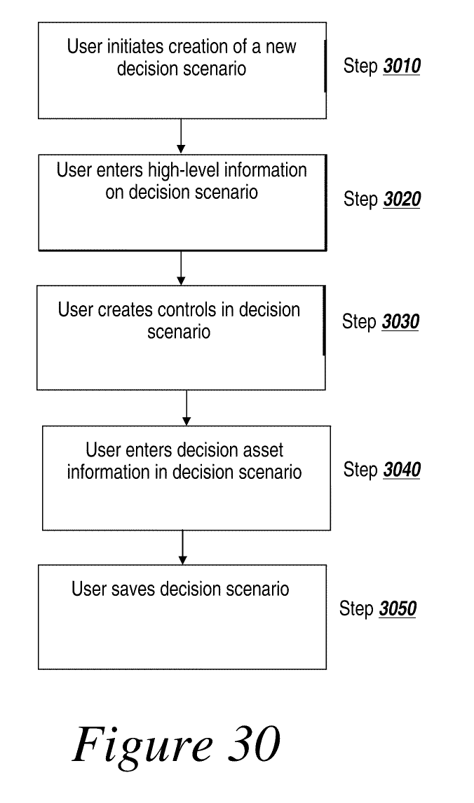

The user may create one or more new scenarios in GUI 1400. FIG. 30 illustrates an exemplary flowchart for creating a new scenario. In step 3010, the user may initiate creation of a new scenario, e.g. by selecting the “new scenario” option in Main Menu 1410. Selecting this option may present the user with a blank canvas of a scenario on which different scenario components may be dropped.

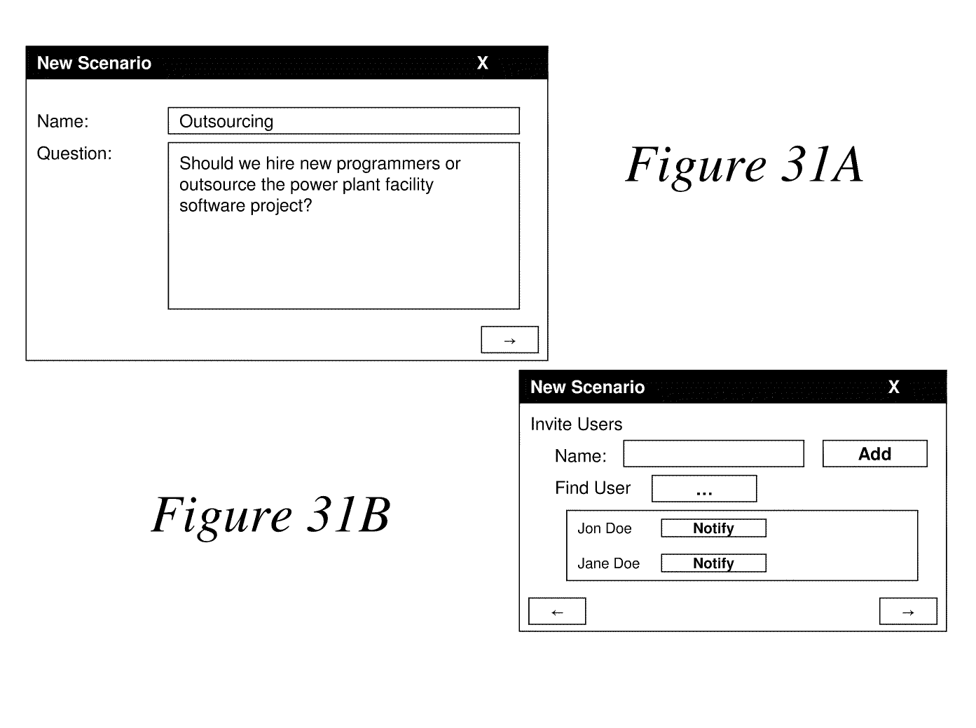

In step 3020, the user may be provided with one or more user interfaces to enter high-level information on the new scenario. FIG. 31A illustrates an exemplary user interface in which the user may enter a name and a question or problem in corresponding text-fields for the new scenario. FIG. 31B illustrates a user interface in which the user may invite other users to access or collaborate on the new decision surface. Similarly, the user may be presented with a user interface to specify other scenarios related to the new scenario.

In step 3030, the user may create one or more controls in the scenario. The user may initiate creation of a control by selecting the “new control” option in Scenario Menu 1420. Alternatively, the user may drop previously-created controls into the decision surface, e.g. by selecting the “open control” option in Scenario Menu 1420. Each control may provide its own data visualizer to display data that may be useful to the user in making a decision. FIG. 29 illustrates two exemplary data visualizers corresponding to two controls.

The user may also move and edit the controls once they are placed in the scenario. A user may select multiple controls at the same time, perhaps for grouping or rearrangement.

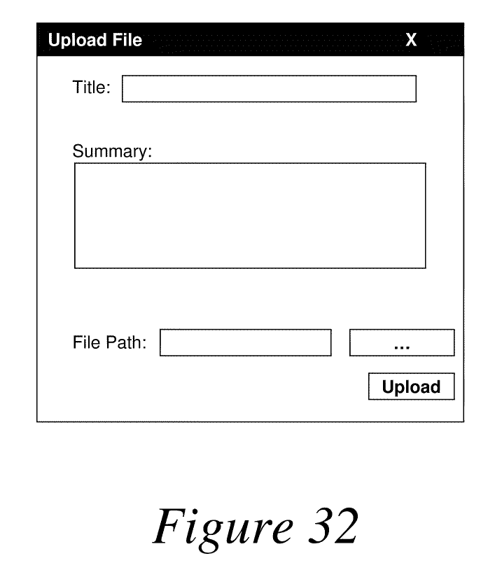

In step 3040, the user may enter asset information in the scenario. Examples of asset information include, but are not limited to, data and files used in the decision, events, activities, performance variables, collaborations, documents, relevant knowledge sources, and decisions. FIGS. 31A, 31B, and 32 depict exemplary wizards for creating a decision. FIG. 31A depicts a dialog box that allows a user to enter a description of a Question or Problem to be addressed by a decision. FIG. 31B depicts an exemplary dialog box that allows a user to invite other users or collaborators to contribute information, ideas, or resources to the decision-making process. FIG. 32 depicts an exemplary file upload dialog for uploading Files for use in a scenario.

In step 3050, after fully configuring the scenario, the user may save the scenario on a storage device. The user may select the “save scenario” option in the main menu 1410 to save the scenario.

Scenarios provided by exemplary embodiments may be used in different processes including, but not limited to, decision-making processes and data analysis. For example, when making a decision on hiring new employees, a scenario creator may create a new scenario associated with this decision by selecting a “create new scenario” option from the Main Menu 1410. The scenario creator may create resources (e.g. controls, workflows, processes, etc) in the scenario to represent the decision-making process. The scenario creator may assign portions of the decision-making process to other users by inviting these users to this scenario. The different users of the scenario may communicate with each other using the Messaging Unit 1430. The users may collaborate at different steps in the decision-making process, refactor the process represented in the scenario to incorporate new findings, close certain portions of the process that have already been resolved, and ultimately come to a determination. Once a determination is made, the asset represented within the scenario, along with the collaborations, may be saved and archived for later retrieval.

Scenarios may be used not only for processes that involve known quantities of data, e.g. in the operational example of hiring new employees, but also for “ad-hoc” decision-making. These scenarios may be used to ultimately generate and store assets which may be leveraged in making future decisions and/or in looking for opportunities to template future decision-making processes.

As an example, a committee may be formed in an organization to research a topic which involves unknown “unknowns,” e.g. whether to acquire an unrelated business like an Automobile Sales company. That is, the committee may not yet know which aspects of the topic may need to be researched. Exemplary embodiments may allow creation of a scenario associated with the topic, and creation of resources (e.g. controls, workflows, processes, etc) in the scenario to represent the topic. The scenario creator may assign portions of the decision-making process to other users by inviting these other users to this scenario. The users may collaborate at different steps in the decision-making process, refactor the process represented in the scenario to incorporate new findings, close certain portions of the process that have already been resolved, and ultimately come to a determination. Once a determination is made, the asset represented within the scenario may be saved and archived for later retrieval.

In this example, the committee may use the scenario to reach a decision to acquire the Automobile Sales company. Subsequently, the organization may be presented with an opportunity to acquire another business in the same domain, like an Automobile Service company. This situation involves some unknown “unknowns” and some known “unknowns” because the Service and Sales companies are both in the Automobile industry.

A scenario creator may create a scenario to represent and facilitate the decision-making process with regard to the Automobile Service company. Rather than create a new scenario for the Automobile Service company, the scenario creator may use the affinity feature of scenario creation to find the research process encapsulated in the asset for the Automobile Sales company. Creation of an asset for the Automobile Service company may require some of the same research components as in the archived asset for the Automobile Sales company, because both companies are in the Automobile industry. Thus, the scenario creator may decide to begin with the archived asset/template for the Automobile Sales company but remove resources (controls, visualizers, processes, collaboration features) that pertain to the purchasing of a Sales company but not a Service company.

The scenario creator may then create additional resources (e.g. controls, visualizers, workflows, processes, etc) in the scenario. The scenario creator may assign portions of the decision-making process to other users by inviting these other users to this scenario. The users may collaborate at different steps in the decision-making process, refactor the process represented in the scenario to incorporate new findings, close certain portions of the process that have already been resolved, and ultimately come to a determination. Once a determination is made, the asset represented within the scenario may be saved and archived for later retrieval.

Thus, as the business acquires other businesses across various domains, the processes generated using exemplary embodiments gain some commonalities across the domains. This represents expertise embodied in the archived templates, scenarios and assets that may be leveraged when making future decisions.

A user may use exemplary embodiments to create a template that could be used across the organization for a certain general situation, e.g. acquiring a business in an unfamiliar domain. Mechanisms may be provided by exemplary embodiments to continually evaluate the effectiveness of such templates. The evaluation mechanisms may include, but are not limited to, direct user feedback to the template creator via collaboration tools provided in the scenarios. The evaluation mechanisms may also include automated follow-up effectiveness questionnaires that allow the decision-makers to use hindsight to modify the template for future use. The evaluation mechanisms may further include use of statistics on the template's usage, e.g. how much the template is being used, how the template is being modified by users, if the modifications are additive or subtractive, etc. The evaluation mechanisms force evaluation of operational-type features so that processes provided in templates keep pace with the needs of the organization. The evaluation mechanisms also reduce operational feedback latency, facilitate organizational change, and keep the organization operationally agile.

In continuing the Automobile industry example, subsequent to the purchase of an Automobile industry business, the organization may decide to pull out of the Automobile industry and sell all its businesses in that domain. Having received good returns from the Automobile industry, the shareholders of the organization may complain and demand an explanation. A user may retrieve all archived assets related to the Automobile industry, including the asset representing the initial research into the industry's viability. The archived assets may contain not only data, data visualization and data analysis, but also the original context of the decisions and collaborations among committee members. The user may analyze these archived assets to support and explain a decision to pull out of the Automobile domain and/or to discover why the organization decided to enter the Automobile domain in the first place.

The exemplary embodiments described herein provide systems, devices, and methods for recognizing, interpreting, encapsulating, preserving, and facilitating access to information, particularly information relevant to a decision-making process. Although the invention is described with reference to exemplary embodiments, the present invention is not limited to the specific embodiments described herein. One having ordinary skill in the art will recognize that a number of modifications of the embodiments are possible without departing from the scope of the invention.

1. An electronic-device implemented method for encapsulating a decision-making process as a scenario, the method comprising:
displaying an interface on an display device for providing a decision and a resource related to the decision or a reference to a resource related to the decision;
defining a control related to the decision that, when executed by a processor of the electronic device, causes the electronic device to perform an action related to the decision or resource;
encapsulating the decision and the resource or the reference to the resource as an asset;
encapsulating the asset, a problem, and the control as a scenario; and
storing the encapsulated scenario in a storage of the electronic device.

2. The method of claim 1, further comprising calculating an affinity measuring a relationship between the scenario and a second scenario.

3. The method of claim 2, wherein the affinity is calculated based on a similarity between the resource or the reference to the resource encapsulated in the scenario and a resource or a reference to a resource encapsulated in the second scenario.

4. The method of claim 1, further comprising encapsulating performance metrics that are used to indicate a quality of the decision as part of the scenario.

5. The method of claim 4, further comprising:
encapsulating performance variables that measure aspects of the decision as part of the asset; and
comparing the performance variables to the performance metrics to determine the quality of the decision.

6. The method of claim 1, further comprising storing the problem and the resource in the encapsulated scenario as a template.

7. The method of claim 6, further comprising updating the template in response to the scenario being updated.

8. The method of claim 1, wherein the resource or the reference to the resource or the problem is entered from a template.

9. The method of claim 1, wherein the encapsulated scenario is stored in a library.

10. The method of claim 1, further comprising encapsulating a relevant portion of a formal specification of a knowledge source, wherein the formal specification provides a structure for the knowledge source.

11. The method of claim 1, further comprising displaying the scenario on the display device.

12. An electronic device readable storage medium storing electronic device readable instructions that, when executed by a processor, cause the processor to:
accept a decision as an input to the electronic device;
accept a resource related to the decision or a reference to a resource related to the decision as an input to the electronic device;
define a control related to the decision that, when executed by a processor of the electronic device, causes the electronic device to perform an action related to the decision or resource;
encapsulate the decision and the resource or the reference to the resource as an asset;
encapsulate the asset, a problem, and the control as a scenario; and
store the encapsulated scenario in a storage.

13. The medium of claim 12 further comprising instructions for calculating an affinity measuring a relationship between the scenario and a second scenario.

14. The method of claim 13, wherein the affinity is calculated based on a similarity between the resource encapsulated in the scenario and a resource encapsulated in the second scenario.

15. The method of claim 12, further comprising instructions for encapsulating performance metrics that are used to indicate a quality of the decision as part of the scenario.

16. The method of claim 15, further comprising:
instructions for encapsulating performance variables that measure aspects of the decision as part of the asset; and
instructions for comparing the performance variables to the performance metrics to determine the quality of the decision.

17. The method of claim 1, further comprising instructions for storing the problem and the resource in the encapsulated scenario as a template.

18. The method of claim 17, further comprising instructions for updating the template in response to the scenario being updated.

19. The method of claim 1, wherein at least one of the resources or the problem is entered from a template.

20. The method of claim 1, wherein the encapsulated scenario is stored in a library.

21. The method of claim 1, further comprising instructions for encapsulating a relevant portion of a formal specification of a knowledge source, wherein the formal specification provides a structure for the knowledge source.

22. The method of claim 1, further comprising instructions for displaying the scenario on a display device.

23. A computer-implemented method for visualizing data, the method comprising:
providing a control for performing a data-related action, the control comprising an input connection and a data visualizer;
configuring the input connection of the control to connect to an input data source; entering a query at the control;
using the input connection to retrieve a result of the query from the input data source; and
displaying the result of the query in the data visualizer on a display device.

24. The method of claim 23, further comprising:
displaying a portion of the input data source in the data visualizer on a display device.

25. The method of claim 23, further comprising:
storing the control on a storage device.

26. The method of claim 23, further comprising:
storing the result of the query on a storage device.

27. The method of claim 23, wherein the input connection is configurable to connect to a plurality of input data sources.

28. The method of claim 23, wherein the data visualizer is configured to display the result of the query separately from a display of the control.

29. The method of claim 23, wherein the data visualizer is configured to display the result of the query in a display of the control.

30. The method of claim 23, wherein configuring the input connection further comprises:
providing a list of available input data sources; and
selecting the input data source from the list.

31. The method of claim 23 further comprising:
configuring a control connection of the control to connect to a second control, the second control displaying a second result of a second query in a second data visualizer on the display device;
selecting an item in the display of the result in the data visualizer; and
in response to selecting the item, automatically selecting a second item in the second display of the second result in the second data visualizer.

32. The method of claim 23, further comprising:
configuring a control connection of the control to connect to a second control, the second control displaying a second result of a second query in a second data visualizer on the display device;
combining the result of the query and the second result of the second query to generate a combined result; and
displaying the combined result in the data visualizer on a display device.

33. The method of claim 23, further comprising:
determining one or more available formats of the display in the data visualizer, the determining based on a type of the input data source connected to the control; and
selecting a format of the display from the one or more available formats.

34. The method of claim 23, wherein entering the query at the control further comprises:
automatically providing a preferred format for the query, the preferred format based on a type of the input data source.

35. The method of claim 23, further comprising:
providing an interface at the input connection of the control to communicate with the input data source;
converting a first format of the query to a second format at the interface; and
transmitting the query with the second format to the input data source.

36. The method of claim 35, further comprising:
implementing a wrapper function using the interface, the wrapper function converting the first format to the second format.

37. The method of claim 35, further comprising:
converting a first format of the result to a second format at the interface; and displaying the result with the second format in the data visualizer

38. A computer readable storage medium storing computer readable instructions for visualizing data that, when executed by a processor of the computer, cause the processor to:
accept a control for performing a data-related action as an input to the computer, the control comprising an input connection and a data visualizer;
configure the input connection of the control to connect to an input data source; accept a query at the control;
use the input connection to retrieve a result of the query from the input data source; and
display the result of the query in the data visualizer on a display device.

39. The medium of claim 38, further comprising instructions for displaying a portion of the input data source in the data visualizer on the display device.

40. The medium of claim 38, further comprising instructions for storing the control on a storage device.

41. The medium of claim 38, further comprising instructions for storing the result of the query on a storage device.

42. The medium of claim 38, wherein the input connection is configurable to connect to a plurality of input data sources.

43. The medium of claim 38, wherein the data visualizer is configured to display the result of the query separately from a display of the control.

44. The medium of claim 38, wherein the data visualizer is configured to display the result of the query in a display of the control.

45. The medium of claim 38 wherein the instructions for configuring the input connection further comprise:
instructions for providing a list of available input data sources; and
instructions for accepting a selection of the input data source from the list.

46. The medium of claim 38 further comprising:
instructions for configuring a control connection of the control to connect to a second control, the second control displaying a second result of a second query in a second data visualizer;
instructions for selecting an item in the display of the result in the data visualizer; and
instructions for, in response to selecting the item, automatically selecting a second item in the second display of the second result in the second data visualizer.

47. The medium of claim 38, further comprising:
instructions for configuring a control connection of the control to connect to a second control, the second control displaying a second result of a second query in a second data visualizer;
instructions for combining the result of the query and the second result of the second query to generate a combined result; and
instructions for displaying the combined result in the data visualizer.

48. The medium of claim 38, further comprising:
instructions for determining one or more available formats of the display in the data visualizer, the determining based on a type of the input data source connected to the control; and
instructions for accepting a selection a format of the display from the one or more available formats.

49. The medium of claim 38, wherein the instructions for entering the query at the control further comprise:
instructions for automatically providing a preferred format for the query, the preferred format based on a type of the input data source.

50. The medium of claim 38, further comprising:
instructions for providing an interface at the input connection of the control to communicate with the input data source;
instructions for converting a first format of the query to a second format at the interface; and
instructions for transmitting the query with the second format to the input data source.

51. The medium of claim 50, further comprising:
instructions for implementing a wrapper function using the interface, the wrapper function converting the first format to the second format.

52. The medium of claim 50, further comprising:
instructions for converting a first format of the result to a second format at the interface; and
instructions for displaying the result with the second format in the data visualizer
